(19) United States
(12) Patent Application Publication
(10) Pub. No.: US 2015/0282144 A1
(43) Pub. Date: Oct. 1, 2015

(54) BASE STATION DEVICE, TERMINAL DEVICE AND WIRELESS COMMUNICATION SYSTEM

(71) Applicant: SHARP KABUSHIKI KAISHA, Osaka (JP)

(72) Inventors: Hiromichi Tomeba, Osaka-shi (JP); Takashi Onodera, Osaka-shi (JP); Alvaro Ruiz Delgado, Osaka-shi (JP); Minoru Kubota, Osaka-shi (JP)

(21) Appl. No.: 14/438,945

(22) PCT Filed: Oct. 18, 2013
(86) PCT No.: PCT/JP2013/078378

§ 371 Date: Apr. 28, 2015

(30) Foreign Application Priority Data
Oct. 29, 2012 (JP) 2012-237519

(51) Int. Cl. H04W 72/04

(52) U.S. Cl. CPC H04W 72/046; H04W 72/0453; H04W 88/08

(57) ABSTRACT

Degradation in transmission performance due to a feedback error is lessened in a wireless communication system that performs non-linear pre-coding. Provided is a base station device according to the present invention, which includes multiple antennas and which performs non-linear pre-coding and spatial multiplexing on signals destined for multiple terminal devices, and thus performs wireless communication, the base station device including: a channel state information acquisition module 33 that acquires channel state information between the base station device and the terminal device; a perturbation vector search module 27-2 that searches for a perturbation vector which is received by each of the multiple terminal devices and which suppresses inter-user interference, using a linear filter that is generated based on the channel state information; and a transmit signal generation module 27-3 that calculates a transmit signal vector based on the generated linear filter, the perturbation vector and a transmit data vector.

### TECHNICAL FIELD

The present invention relates to a technology of performing multi-user multiple input multiple output transfer.

### BACKGROUND ART

In a wireless communication system, in order to provide various broadband information services, it is desirable at all times that transfer speed is improved. It is possible to realize an improvement in the transfer speed by broadening a communication bandwidth, but because there is a limit in an available frequency band, an improvement in spectral efficiency is indispensable. As a technology for greatly improving spectral efficiency, a multiple input multiple output (MIMO) technology that performs wireless transmission using multiple transmit and receive antennas is attracting attention, and is practically used in a cellular system, a wireless LAN system, or the like. An amount of improvement in the spectral efficiency due to the MIMO technology is proportional to the number of the transmit and receive antennas. However, there is a limit in the number of receive antennas that may be in a terminal device. Thus, multi-user MIMO (MU-MIMO) in which multiple terminal devices that make connections at the same time are regarded as a virtual large-scale antenna array, and transmission signals from the base station device to each terminal device are space-multiplexed is effective in improving the spectral efficiency.

In MU-MIMO, because the transmission signals that are destined for the terminal devices, respectively, are received in the terminal device, causing inter-user-interference (hereinafter referred to as IUI), IUI needs to be suppressed. For example, in Long term evolution that is employed as one of the 3.9-th mobile wireless communication systems, linear pre-coding is employed in which multiplication by a linear filter that is calculated based on channel state information that each terminal device notifies of is performed in advance in the base station device and thus the IUI is suppressed.

Furthermore, as a method of realizing MU-MIMO with which much greater improvement in spectral efficiency can be expected, a MU-MIMO technology that uses non-linear pre-coding in which non-linear processing is performed on the side of the base station device has attracted attention. In a case where a modulo operation is possible in the terminal device, it is possible to add a perturbation vector of which an element is a complex number (a perturbation term) that results from multiplying an arbitrary Gaussian integer by a fixed real number, to the transmission signal.

Then, if the perturbation vector is appropriately set according to a channel state between the base station device and each of multiple terminal devices, it is possible to reduce the needed transmission power more greatly than in the linear pre-coding. As the non-linear pre-coding, vector perturbation (VP) disclosed in NPL 1 or Tomlinson Harashima precoding (THP) disclosed in NPL 2, which are schemes with which optimal transmission performance can be realized, is well known.

Incidentally, because the pre-coding is performed according to the channel state between the base station and the terminal device, the precision of the pre-coding depends greatly on the precision of channel state information (CSI) which the base station can be aware of. In the wireless communication system that depends on frequency division duplex that uses different carrier frequencies in downlink transfer and uplink transfer, the CSI estimated by the terminal device is fed back to the base station device, and thus the base station device can be aware of the CSI. However, there is a likelihood that an error will occur between the CSI that the base station device can be aware of and actual CSI. This problem is briefly described referring to FIG. 9.

FIG. 9 is a sequence chart illustrating a situation of communication between the base station device that performs the pre-coding and the terminal device. First, the base station device transmits a reference signal for estimating the CSI to the terminal device (Step S1). Furthermore, the base station device generates transmit data and a demodulation reference signal (Step S2). Because the reference signal is already known to the base station device and the terminal device, the terminal device can estimate the CSI based on the received reference signal (Step S3).

However, practically, because noise is necessarily applied to the receive signal, an error occurs between the estimated CSI and real CSI. The terminal device converts the estimated CSI into information that is available for notification to the base station device, and notifies the base station device of the resulting information (Step S4). As the information that is available for the notification, information that results from quantizing the estimated information directly into digital information, a number indicating a code listed in a code book that is shared between the base station device and the terminal device, or the like is given. The base station device restores the CSI with the notified information, but an error occurs between the restored CSI and the real CSI, too. The error between the real CSI and the CSI that the base station device is finally made to be aware of is hereinafter referred to as a quantization error. Thereafter, the base station device performs the pre-coding based on the restored CSI (Step S5), and the data transmission to the terminal device is performed (Step S6).

When receiving data from the base station device, the terminal device performs channel estimation for demodulation (Step S7), performs channel equalization (spatial signal detection processing) (Step S8), and demodulates the transmit data (Step S9). At this point, because the terminal device estimates the CSI, a fixed processing delay time (also referred to as round trip delay or process delay) occurs before the base station device performs the pre-coding processing and transmits a signal. Normally, because time selectivity is present in a channel, an error occurs between the CSI that is propagated by a signal on which the pre-coding is performed, and the CSI estimated by the terminal device. The CSI error that occurs depending on the time selectivity in the channel is hereinafter referred to as a time change error and the quantization error and the time change error are hereinafter referred to together as a feedback error. Because the feedback error is present in the CSI that the base station device can be aware of, it is significantly difficult for the base station device to acquire high-precision CSI.

On the other hand, in a wireless communication system that depends on time division duplex that uses the same carrier frequencies in the downlink transfer and the uplink transfer, the feedback error occurs as well, as is the case with the frequency division duplex. This problem is briefly described referring to FIG. 10. FIG. 10 is a sequence chart illustrating a situation of the communication between the base station device that performs the pre-coding and the terminal device. In the time division duplex, the transmission is performed in a state where the uplink transfer and the downlink transfer are divided in terms of time. First, the uplink transfer from the terminal device to the base station device is performed (Step T1). At this time, a reference signal for signal demodulation is included in a signal for the uplink transfer, and the base station device acquires the CSI from the reference signal and performs signal demodulation (Step T2).

Subsequently, it is considered that the base station device performs the pre-coding on a signal for the downlink transfer. At this time, because duality is present between a channel for the uplink, and a channel for the downlink in the time division duplex, the base station device can perform the pre-coding based on the CSI that was acquired some time ago to demodulate the signal for the uplink transfer (Step T3). Then, data is transmitted to the terminal device (Step T4). On the other hand, in the terminal device, the channel estimation and the downlink signal demodulation are performed (Step T5).

However, generally, because multiple signals for the uplink transfer and multiple signals for the downlink transfer are alternately transmitted, the time change error is present between the CSI that is propagated by a signal that is transmitted, which is in the latter half of the multiple signals for the downlink transfer, and the CSI that is used in the pre-coding. Furthermore, because the duality is present in the channel itself and on the other hand, the duality is not present in analog circuits of the base station device and the terminal device, the CSI for the uplink and the CSI for the downlink are not necessarily the same. CSI errors that occur in this manner are hereinafter referred to together as the feedback error.

As described above, in order to improve the transmission performance of the pre-coding transfer in an environment where an influence of the CSI feedback error is great, NPL 3 discusses a method in which the terminal device estimates channel state information anew at a point in time at which a receive signal on which the pre-decoding is performed is received in the terminal device, and based on the channel state information, performs approximate channel equalization processing anew, thereby lessening degradation in the transmission performance due to the feedback error. However, in the method in NPL 3, a case where only a data stream is sent to each terminal device is assumed and only the linear pre-coding is considered for the pre-coding.

### CITATION LIST

### Non Patent Literature

NPL 1: B. M. Hochwald, et. al., “A vector-perturbation technique for near-capacity multiantenna multiuser communication-Part II: Perturbation,” IEEE Trans. Commun., Vol. 53, No. 3, pp. 537-544, March 2005.
NPL 2: M. Joham, et. al., “MMSE approaches to multiuser spatio-temporal Tomlinson-Harashima precoding”, Proc. 5th Int. ITG Conf. on Source and Channel Coding, Erlangen, Germany, Jan. 2004.
NPL 3: IEEE 802.11-09/1234r1, “Interference cancellation for downlink MU-MIMO,” Qualcomm, March 2010.

### SUMMARY OF INVENTION

### Technical Problem

In a transfer system that is based on the non-linear pre-coding, in order to realize high spectral efficiency, degradation in the transmission performance that occurs due to the CSI feedback error needs to be dealt with. However, in the method in NPL 3, it is difficult to transmit multiple data streams to each terminal device, and the pre-decoding that can be applied is also limited to the linear pre-decoding. To be more precise, in a case where the multiple data streams are transmitted to each terminal device and the non-linear pre-coding is performed, the method of lessening the degradation in transmission performance due to the feedback error has not yet been made clear.

An object of the present invention, which is made in view of this situation, is to provide a base station device and a terminal device, all of which are capable of lessening degradation in transmission performance due to a feedback error in the wireless communication system that performs non-linear pre-coding.

### Solution to Problem

(1) In order to accomplish the object described above, the present invention is contrived to provide the following means. That is, according to an aspect of the present invention, there is provided a base station device that includes multiple antennas and which performs non-linear pre-coding and spatial multiplexing on signals destined for multiple terminal devices and thus performs wireless communication, the base station device including: a channel state information acquisition module that acquires channel state information between the base station device and the terminal device; a perturbation vector search module that searches for a perturbation vector which is received by each of the multiple terminal devices and which suppresses inter-user interference, using a linear filter that is generated based on the channel state information; and a transmit signal generation module that calculates a transmit signal vector based on the generated linear filter, the perturbation vector and a transmit data vector.

(2) Furthermore, in the base station device according to the present invention, the perturbation vector search module may perform a first method in which perturbation term candidate points that are expressed using Gaussian integers of which the number is determined in advance are searched for the perturbation vector, or a second method in which the perturbation vector that is received by at least one terminal device among multiple terminal devices and that suppresses the inter-user interference is searched for.

(3) Furthermore, in the base station device according to the present invention, based on at least one among a modulation scheme, a coding rate, and the channel state information, which are applied to the signals, the perturbation vector search module may use the first method or the second method at the same time or selectively.

(4) Furthermore, in the base station device according to the present invention, in time or frequency domains, the perturbation vector search module may periodically allocate the terminal device that suppresses the inter-user interference, among the multiple terminal devices.

(5) Furthermore, in the base station device according to the present invention, the channel state information acquisition module may acquire first channel state information based on control information associated with the first channel state information that is notified by each of the multiple terminal devices, and may acquire error information between the first channel state information and the control information or error information between the first channel state information and second channel state information on a channel on which the signals are propagated as wireless signals based on the first channel state information.

(6) Furthermore, in the base station device according to the present invention, the channel state information acquisition module may acquire first channel state information based on control information associated with the first channel state information that is notified by each of the multiple terminal devices, and may acquire error information between the first channel state information that is notified by each of the multiple terminal devices and the control information or error information between the first channel state information and second channel state information on a channel on which the signals are propagated as wireless signals.

(7) Furthermore, in the base station device according to the present invention, based on the first channel state information and the error information, non-linear pre-coding may be performed on the signals.

(8) Furthermore, in the base station device according to the present invention, the perturbation vector search module may search for the perturbation vector that is received by the terminal device which has a large amount of error information, and that suppresses the inter-user interference.

(9) Furthermore, according to another aspect of the present invention, there is provided a terminal device that receives wireless signals on which non-linear pre-coding and spatial multiplexing are performed from a base station device that includes multiple antennas, the terminal device including: a reference signal separation module that separates a data signal and a reference signal from each of the wireless signals; a channel state estimator that estimates first channel state information between the base station device and the terminal device based on the reference signal; a feedback information generation module that generates control information associated with the first channel state information that is notified to the base station device, from the first channel state information; and a wireless transmission module that transmits the control information to the base station device, in which the feedback information generation module generates error information between the first channel state information and the control information.

(10) Furthermore, in the terminal device according to the present invention, the feedback information generation module may generate error information between second channel state information between the terminal device and the base station device on which the data signal that is received at a first point in time or on a first frequency is propagated, and the first channel state information that is estimated based on the reference signal that is received at a second point in time or on a second frequency.

(11) Furthermore, according to a further aspect of the present invention, there is provided a wireless communication system including: the base station device according to (1); and the multiple terminal devices according to (9).

### Advantageous Effects of Invention

According to the present invention, in the wireless communication system that performs the non-linear pre-coding, because the degradation in the transmission performance due to the feedback error can be improved, this can contribute to considerable improvement in spectral efficiency.

### BRIEF DESCRIPTION OF DRAWINGS

FIG. 1 is a diagram schematically illustrating a wireless communication system according to a first embodiment of the present invention.

FIG. 2 is a block diagram illustrating a configuration of a base station device according to the first embodiment of the present invention.

FIG. 3 is a block diagram illustrating a device configuration of the pre-coding module 27 according to the first embodiment of the present invention.

FIG. 4A is a diagram of a complex plane for describing perturbation terms that are set to be candidates by the perturbation vector search module 27-2 according to the first embodiment of the present invention.

FIG. 4B is a diagram of a complex plane for describing the perturbation terms that are set to be the candidates by the perturbation vector search module 27-2 according to the first embodiment of the present invention.

FIG. 4C is a diagram of a complex plane for describing the perturbation terms that are set to be the candidates by the perturbation vector search module 27-2 according to the first embodiment of the present invention.

FIG. 4D is a diagram of a complex plane for describing the perturbation terms that are set to be the candidates by the perturbation vector search module 27-2 according to the first embodiment of the present invention.

FIG. 5A is a diagram of another complex plane for describing the perturbation terms that are set to be the candidates by the perturbation vector search module 27-2 according to the first embodiment of the present invention.

FIG. 5B is a diagram of another complex plane for describing the perturbation terms that are set to be the candidates by the perturbation vector search module 27-2 according to the first embodiment of the present invention.

FIG. 5C is a diagram of another complex plane for describing the perturbation terms that are set to be the candidates by the perturbation vector search module 27-2 according to the first embodiment of the present invention.

FIG. 5D is a diagram of another complex plane for describing the perturbation terms that are set to be the candidates by the perturbation vector search module 27-2 according to the first embodiment of the present invention.

FIG. 6 is a block diagram illustrating a device configuration of an antenna module 29 according to the first embodiment of the present invention.

FIG. 7 is a block diagram illustrating a configuration of a terminal device according to a first embodiment of the present invention.

FIG. 8 is a block diagram illustrating a configuration of a terminal antenna module 51 according to the first embodiment of the present invention.

FIG. 9 is a sequence chart illustrating a situation of communication between the base station device that performs pre-coding and the terminal device.

FIG. 10 is a sequence chart illustrating a situation of the communication between the base station device that performs the pre-coding and the terminal device.

### DESCRIPTION OF EMBODIMENTS

A wireless communication system according to an embodiment of the present invention will be described below referring to the drawings. Moreover, describing matters according to the present embodiment is an aspect of an understanding of the invention, and therefore contents of the invention are not interpreted subject to being limited to the present embodiment. Unless otherwise specified, A^{T} is hereinafter set to indicate a transposed matrix of a matrix A, A^{H} an adjoint (Hermitian transpose) matrix of the matrix A, A⁻¹ an inverse matrix of the matrix A, A⁺ a pseudo (or general)—inverse matrix of the matrix A, diag(A) a diagonal matrix that results from extracting only a diagonal component of the matrix A, floor(c) a floor function that returns a maximum Gaussian integer of which a real part and an imaginary part do not exceed a value of a real part of a complex number c and a value of an imaginary part of the complex number c, respectively, E[x] an ensemble average of a random variable x, abs(c) a function that returns an amplitude of the complex number c, angle(c) a function that returns an argument of the complex number c, ∥a∥ a norm of a vector a, x % y a remainder that results from dividing an integer x by an integer y, and ₙCₘ the total number of combinations that results from selecting m different elements from among n different elements. Furthermore, [A;B] is set to indicate a matrix that results from adding a matrix A and a matrix B in the row direction, and [A,B] a matrix that results from adding a matrix A and a matrix B in the column direction. Furthermore, Z[i] is set to indicate a set of all Gaussian integers. Moreover, a Gaussian integer indicates a complex number of which a real part and an imaginary part are expressed as integers.

### 1. First Embodiment

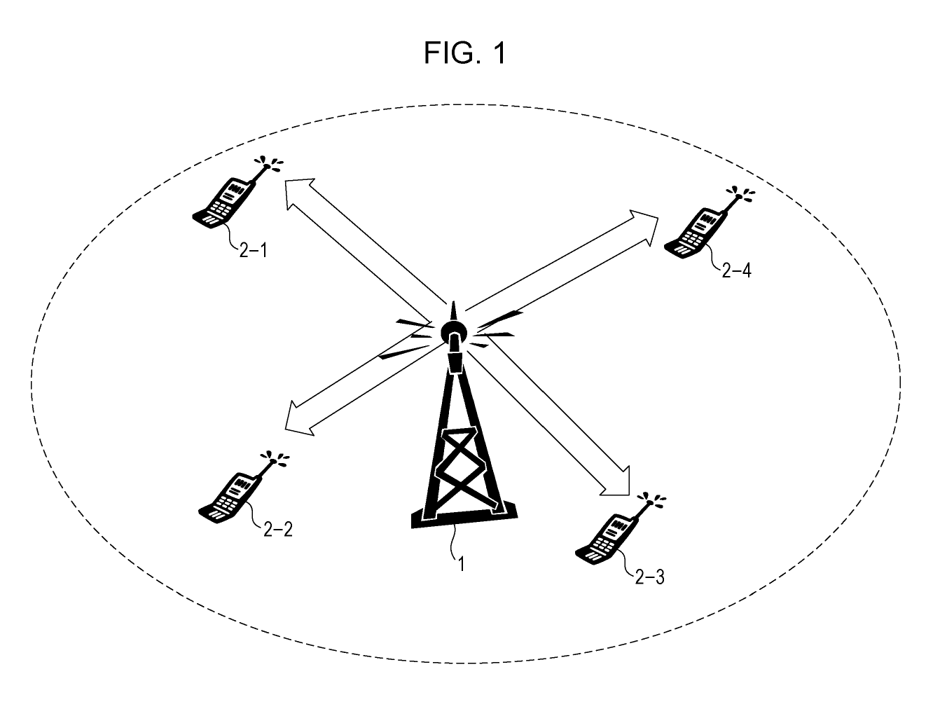

FIG. 1 is a diagram schematically illustrating a wireless communication system according to a first embodiment of the present invention. The first embodiment is for MU-MIMO transfer in which U terminal devices 2 (which are also referred to as wireless reception devices) (4 terminal devices 2-1 to 2-4 in FIG. 1) each of which has Nᵣ receive antennas, are connected to a base station device 1 (which is also referred to as a wireless transmission device) that has Nₜ transmit antennas and in which non-linear pre-coding is available. L pieces of data are set to be transmitted to each of the terminal devices 2 at the same time (the number of pieces of data that are transmitted at the same time is also referred to as a ranking number), and U×L=Nₜ and L=Nᵣ are set to be established.

For simplicity, both of the number of receive antennas of each of the terminal devices 2 and the ranking number are described below as being set to be the same, that is, L=Nᵣ=1, but even though the number of receive antennas and the ranking number differ from one terminal device 2 to another, this does not pose no problem. Furthermore, if U×L≦Nₜ and L≦Nᵣ are satisfied, the ranking number and the number of receive antennas also do not need to be the same.

Orthogonal Frequency Division Multiplexing (OFDM) that has N_{c} subcarriers is assumed to be a transmission scheme. However, unless otherwise specified, signal processing that is described below is set to be performed in every subcarrier. Furthermore, Frequency Division Duplex (FDD) is assumed to be a duplex scheme. The base station device 1 is set to acquire Channel State Information (CSI) on each of the terminal devices 2 using control information that is notified by each of the terminal devices 2 and is set to perform pre-coding on transmit data in every subcarrier based on the channel state information.

First, the CSI between the base station device 1 and the terminal device 2 is defined. According to the present embodiment, a semi-static frequency selective fading channel is assumed. At this point, being semi-static is assumed to mean that a channel does not change within 1 OFDM signal. A channel matrix H(k,t) is defined as in Equation (1) when a complex channel gain in a k-th subcarrier is set to h_{u,m,n}(k,t), in a t-th OFDM signal between an n-th transmit antenna (n=1 to Nₜ) and an m-th receive antenna (m=1 to Nᵣ) of a u-th terminal device 2-u (u=1 to U).

$$\begin{matrix}[ Math . 1 ] & \\ \{ \begin{matrix}H ( k , t ) = ( \begin{matrix}{h}_{1} ( k , t ) \\ {h}_{2} ( k , t ) \\ ⋮ \\ {h}_{U} ( k , t )\end{matrix} ) \\ {h}_{u} ( k , t ) = ( \begin{matrix}{h}_{u , 1 , 1} ( k , t ) & … & {h}_{u , 1 , {N}_{t}} ( k , t ) \\ ⋮ & ⋱ & ⋮ \\ {h}_{u , {N}_{r} , 1} ( k , t ) & … & {h}_{u , {N}_{r} , {N}_{t}} ( k , t )\end{matrix} )\end{matrix} & ( 1 )\end{matrix}$$

hᵤ(k,t) indicates a Nᵣ×Nₜ matrix that is configured from the complex channel gain that is observed in the u-th terminal device 2-u. According to the present embodiment, unless otherwise specified, the CSI indicates a matrix that is configured from the complex channel gain. However, a spatial correlation matrix or a matrix in which linear filters listed in a code book that is shared in advance between the base station device 1 and each of the terminal devices are put side by side may be regarded as the CSI, and it is also possible to perform signal processing described below. Furthermore, in a case where the terminal device 2 notifies the base station device 1 of an eigenvector that is obtained by performing singular value decomposition (or an eigenvalue decomposition) on an estimated channel matrix, the base station device 1 may regard a matrix in which the eigenvectors are put side by side, as the CSI. The u-th terminal device 2-u is described below as estimating CSI hᵤ(k,t₁) at a point in time t₁, performing quantization and then notifying the base station device 1 of a result of the estimation and quantization.

At this point, the CSI that is actually notified by the u-th terminal device 2-u to the base station device 1 is defined as h_{FB,u}(k,t₁). As is the case with hᵤ(k,t₁), h_{FB,u}(k, t₁) is described below as an Nᵣ×Nₜ matrix, but does not necessarily need to be Nᵣ×Nₜ. For example, a case where the u-th terminal device 2-u that includes Nᵣ receive antennas notifies only the CSI relating to (Nᵣ−1) receives antennas is also considered. In this case, of course, h_{FB,u}(k,t₁) is a (Nᵣ−1)×Nₜ matrix. At this time, the base station device 1 may perform transmit signal processing, such as the pre-coding described below, assuming that the number of receive antennas that is included in the u-th terminal device 2-u is (Nᵣ−1).

Furthermore, a case where an eigenvector that is obtained by performing singular value decomposition on hᵤ(k,t₁) or both of an eigenvector and a single value are notified, not hᵤ(k,t₁) itself, is also considered. In this case, for the eigenvector, Nₜ column vectors, each of which has Nₜ elements, are present. However, a vector that can be a linear filter that points a null beam toward the u-th terminal device 2-u that is a destination is included in the eigenvector that is calculated at this point. It is also possible for the u-th terminal device 2-u to perform control in such a manner that column vectors of which the number is arbitrary are notified among multiple eigenvectors. For example, if the u-th terminal device 2-u notifies Q eigenvectors among the eigenvectors, the base station device 1 may perform the transmit signal processing such as the pre-coding described below, assuming that the number of receive antennas that are included in the u-th terminal device 2-u is Q.

According to the present embodiment, a method in which the u-th terminal device 2-u notifies the base station device 1 of h_{FB,u}(k,t₁) has no limitation whatsoever. A specific example of the notification method will be described below. The base station device 1 is described below as being able to ideally recognize h_{FB,u}(k,t₁) that is expressed as an Nᵣ×Nₜ matrix.

[1.1 Base Station Device 1]

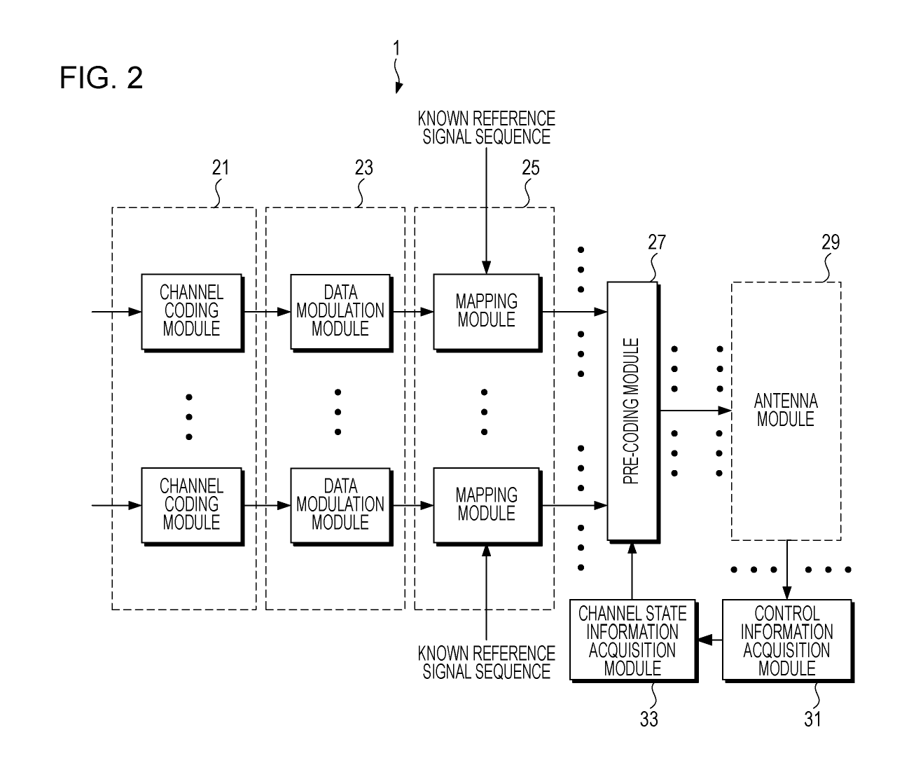

FIG. 2 is a block diagram illustrating a configuration of the base station device 1 according to the first embodiment of the present invention. As illustrated in FIG. 2, the base station device 1 is configured to include a channel coding module 21, a data modulation module 23, a mapping module 25, a pre-coding module 27, an antenna module 29, a control information acquisition module 31, and a channel state information acquisition module 33. As many pre-coding modules 27 as the number N_{c} of subcarriers are present and as many antenna modules 29 as the number Nₜ of transmit antennas are present.

First, the control information acquisition module 31 acquires pieces of control information that are notified by each of the terminal devices 2 in a connected state, and outputs information associated with the channel state information, among the pieces of control information, to the channel state information acquisition module 33. In the channel state information acquisition module 33, based on information being input from the control information acquisition module 31, h_{FB,u}(k,t₁) that is notified from each of the terminal devices 2 is acquired. Then, the channel state information acquisition module 33 calculates a quantization channel matrix H_{FB}(k,t₁) that is expressed in Equation (2), based on h_{FB,u}(k,t₁).

$$\begin{matrix}[ Math . 2 ] & \\ {H}_{FB} ( k , {t}_{1} ) = ( \begin{matrix}{h}_{FB , 1} ( k , {t}_{1} ) \\ ⋮ \\ {h}_{FB , U} ( k , {t}_{1} )\end{matrix} ) & ( 2 )\end{matrix}$$

According to the present embodiment, because it is assumed that Nᵣ=1, H_{FB}(k,t₁) is a U×Nᵣ matrix. The channel state information acquisition module 33 outputs the calculated H_{FB}(k,t₁) to the pre-coding module 27.

Subsequently, the channel coding module 21 performs channel coding on a sequence of pieces of transmit data that are destined for each of the terminal devices 2, and then the data modulation module 23 performs digital data modulation such as QPSK or 16 QAM. The data modulation module 23 inputs a data signal on which the data modulation is performed into the mapping module 25.

The mapping module 25 performs mapping (also referred to as scheduling or resource allocation) that arranges each piece of data in designated radio resources (also referred to as resource elements, or simply resources). At this point, the radio resources mainly indicate frequencies, time, codes, and spaces. The radio resources being used are determined based on received quality that is observed in the terminal device 2, orthogonality of space-multiplexed channels of the terminals, or the like. According to the present embodiment, the radio resources being used are set to be determined in advance, and are set to be recognizable in both of the base station device 1 and each of the terminal devices 2. Moreover, the mapping module 25 also performs multiplexing of a known reference signal sequence for performing channel estimation in each of the terminal devices 2.

Reference signals that are destined for each of the terminal devices 2 are set to be multiplexed in such a manner that the reference signals are orthogonal to one another so that the reference signals can be separated in the terminal devices 2 that receive the reference signals. Furthermore, two reference signals, that is, CSI-reference signals (CSI-RS) that are reference signals for channel estimation and a demodulation reference signal (DMRS) are set to be multiplexed onto the reference signal, but a configuration in which other reference signals are also multiplexed poses no problem. The CSI-RS is for estimating the CSI that is observed in each of the terminal devices 2, and the DMRS is for estimating the channel state information in which a result of the pre-coding described below is reflected. According to the present invention, the mapping module 25 is set to map a data signal, a DMRS, and a CSI-RS in such a manner that the data signal, the DMRS and the CSI-RS are transmitted at different times or on different frequencies. Furthermore, the mapping module 25 arranges the CSI-RS's in such a manner that the CSI-RS's are orthogonal to one another between transmit antennas. Furthermore, the mapping module 25 arranges the DMRS's in such a manner that the DMRS's are orthogonal to one another between the terminal devices and between data streams associated with one another. The mapping module 25 inputs pieces of mapped data information and the like into the pre-coding module 27 for subcarriers that correspond to the pieces of mapped data information, respectively.

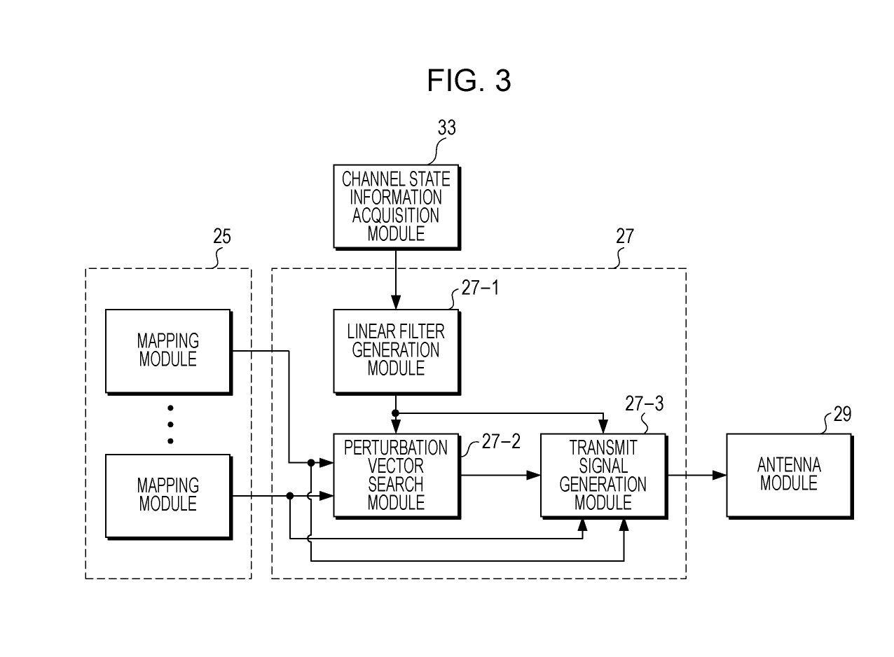

FIG. 3 is a block diagram illustrating a device configuration of the pre-coding module 27 according to the first embodiment of the present invention. As illustrated in FIG. 3, the pre-coding module 27 is configured to include a linear filter generation module 27-1, a perturbation vector search module 27-2, and a transmit signal generation module 27-3. Signal processing by the pre-coding module 27 of the transmit data that is transmitted at a point in time t₂ is described below. Moreover, t₂>t₁ is set to be established.

Input into the pre-coding module 27 is d(k,t₂)=[d₁(k,t₂) and so forth up to d_{U}(k,t₂)]^{T} that is an output from the mapping module 25, which includes the transmit data that is destined for each of the terminal devices 2, which is transmitted on the k-th subcarrier at the point in time t₂, and a channel matrix H_{FB}(k,t₁) of the k-th subcarrier, that is, the quantization channel matrix, which is an output from the channel state information acquisition module 33. For simplicity, descriptions of a subcarrier index k and time indexes t₁ and t₂ are omitted.

The pre-coding module 27 calculates a linear filter W for initially suppressing IUI in the linear filter generation module 27-1. A method of calculating the linear filter W has no limitation whatsoever. For example, the calculation may be performed based on a ZF norm (W=H_{FB}⁺) in which the IUI is suppressed completely or an MMSE norm (W=H_{FB}^{H}(H_{FB}H_{FB}^{H}+αI)⁻¹) in which a mean squared error for a transmit signal and a receive signal is minimized. At this point, α is a control term for controlling an amount of remaining IUI. The linear filter generation module 27-1 determines α based on transmit power or on the number of spatial multiplexing terminals and on desired received quality. For example, α may be set to a reciprocal of an average Signal-to-Noise power Ratio (SNR) per one terminal device. Moreover, the linear filter generation module 27-1 may calculate the linear filter W in such a manner that a total of mean squared errors for multiple subcarriers is set to be minimized. Furthermore, the linear filter generation module 27-1 is described above as calculating the linear filter W in every subcarrier, but the same linear filter may be used in multiple subcarriers. The linear filter generation module 27-1 outputs the calculated linear filter W to the perturbation vector search module 27-2 and the transmit signal generation module 27-3.

A transmit signal vector s=Wd is calculated by multiplying W that is calculated in the linear filter generation module 27-1 by a transmit data vector d that is expressed by placing pieces of transmit data destined for each of the terminal devices 2 side by side. Actually, s=βWd that results from performing multiplication by a power normalization coefficient β for setting the transmit power to be fixed is the transmit signal vector. The power normalization coefficient β is given in Equation (3).

$$\begin{matrix}[ Math . 3 ] & \\ β = \sqrt{\frac{P}{tr ( WE [ {dd}^{H} ] {W}^{H} )}} & ( 3 )\end{matrix}$$

where P indicates total transmit power. If β=1, this means that an increase in transmit power needed for performing the pre-coding does not occur, and if β<1, this means that the needed transmission power increases. If β=1, this means a case where the linear filter W is an orthogonal matrix.

The base station device 1 can set the linear filter W to be the orthogonal matrix by suitably performing a combination of the terminal devices 2 that perform the spatial multiplexing. However, because such control reduces fairness of opportunity for each of the terminal devices 2 to perform communication, it is desirable that limitation is not imposed on the combination of the terminal devices 2. Furthermore, in a case where the number of the terminal devices 2 that are connected to the base station device 1 is small, occasionally, the combination of the terminal devices 2, in which the linear filter W is set to be an orthogonality matrix, is not present. As a method of avoiding the increase in the needed transmit power, a method of adding a perturbation term to transmit data is considered. The pre-coding with the presence of the precondition that the perturbation term is added to the transmit data is referred to as a non-linear pre-coding.

The perturbation term is expressed as a complex number that results from multiplying an arbitrary Gaussian integer by a real number 2δ that is determined in advance. The terminal device 2 performs signal processing that is a modulo operation (or also referred to as a remainder operation) on the receive signal, and thus can remove the perturbation term. If the real number 2δ is also referred to as a modulo width and is shared among the base station device 1 and the terminal devices, no value poses a problem, but in a case where a minimum distance between signal points is M-value quadrature amplitude modulation of Ω, it is desirable that 2δ=Ω×M^{1/2} is set to be established. For example, in a case of QPSK (4QAM) modulation, 2δ=2×2^{1/2} may be established, and in a case of 16 QAM modulation, 2δ=8×10^{-1/2} may be established. The base station device 1 searches an indefinite number of perturbation terms for a perturbation term that can maximize a power normalization term β and, by adding a result of the search to the transmit data, can ensure fixed received quality at all times without dependency on the combination of the terminal devices 2. In a case where spectral efficiency is set to be maximized, the perturbation term that the base station device 1 has to search for is one that minimizes the needed transmission power, but in a case where desired spectral efficiency or received quality is configured in advance, the search for a perturbation term that can accomplish desired quality is sufficient. Furthermore, the base station device 1 is described above as being set to search all subcarriers for a perturbation term, but the base station device 1 may not search some of the subcarriers for the perturbation term.

First, a method in which the perturbation vector search module 27-2 in the related art searches for the perturbation term is described. In a case where U terminal devices 2 are connected to the base station device 1, the number of all pieces of transmit data that are space-multiplexed is U, and it is possible to add the perturbation term to each of all the pieces of transmit data. Furthermore, because the perturbation term is selected from among arbitrary Gaussian integers, even if the number of selectable Gaussian integers is limited to K, all combinations of the perturbation terms that can be added to the transmit data amounts to up to K^{U}, and it is not realistic to search for all the perturbation terms.

Accordingly, as a well-known method, there is a method of searching for the perturbation term based on Sphere Encoding (SE). In this case, 2δz=2δ[z₁, and so forth up to z_{U}]^{T} that is a combination (a perturbation vector) of optimal perturbation terms that are output by the perturbation vector search module 27-2 satisfies Equation (4).

$$\begin{matrix}[ Math . 4 ] & \\ z = {argmin}_{\{ {z}_{u} ∈ Z [ i ] , u = 1 \sim U \}} {‖ ( d + 2 δ z ) ‖}^{2} & ( 4 )\end{matrix}$$

The perturbation vector search module 27-2 outputs the calculated perturbation vector to the transmit signal generation module 27-3.

The transmit signal generation module 27-3 calculates a transmit signal vector s=βW(d+2δz) based on the linear filter W that is calculated in the linear filter generation module 27-1, a perturbation vector z that is calculated in the perturbation vector search module 27-2, and the transmit data vector d. Moreover, the power normalization term β at this time is calculated anew, considering the perturbation vector z. The power normalization term β is described as being included in the linear filter as well.

Here, the receive signal in a case where the perturbation vector is searched for based on the method in the related art is described. When the base station device 1 transmits a transmit signal vector s=W(d+2δz), the receive signal that is observed by the u-th terminal device 2 in the k-th subcarrier (whose notation is omitted) at the time in point t₂ is given in Equation (5). However, a description of noise is omitted.

$$\begin{matrix} [ Math . 5 ] & \\ \begin{matrix}{r}_{u} ( {t}_{2} ) = {h}_{u} ( {t}_{2} ) W ( d ( {t}_{2} ) + 2 δ z ( {t}_{2} ) ) \\ = {h}_{u} ( {t}_{2} ) {w}_{u} ( {d}_{u} ( {t}_{2} ) + 2 δ {z}_{u} ( {t}_{2} ) ) + {h}_{u} ( {t}_{2} ) {\sum }_{i = 1 , i \neq u}^{U} {w}_{i} ( {d}_{i} ( {t}_{2} ) + 2 δ {z}_{i} ( {t}_{2} ) )\end{matrix} & ( 5 )\end{matrix}$$

At this point, a first term is a desired signal component, and a second term is an inter-user interface (IUI) component. If the u-th terminal device 2-u can ideally notify the base station device 1 of hᵤ(t₂), with pre-coding processing by the base station device 1, it is possible to suppress the IUI. However, as described above, what the u-th terminal device 2-u can notify is h_{FB,u}(t₁) that is calculated based on estimated hᵤ(t₁) at the point in time t₁. Because a linear filter that is calculated by the linear filter generation module 27-1 of the base station device 1 is based on h_{FB,u}(t₁), it is difficult to suppress the IUI that is caused by a transmit signal which is transmitted at the point in time t₂. To be more precise, in the base station device 1, even in a case of the MU-MIMO transfer in which the pre-coding is performed, it is substantially impossible to set the IUI to 0.

The same is also true when the pre-coding is applied based on duality of an uplink channel in the communication system that is based on a time duplex scheme (Time Division Duplex (TDD)). The base station device 1 estimates a channel matrix between the base station device 1 and the terminal device 2 using a reference signal that is included in an uplink transfer signal, and performs the pre-coding on a downlink transfer signal based on the channel matrix. In this case, because uplink transfer and downlink transfer are alternately performed at different times, at least an error due to temporal variation is present between a channel matrix that is estimated by the base station device 1 based on an uplink transfer reference signal and a channel matrix that is actually propagated by the signal on which the pre-coding is performed. For this reason, as is the case with an FDD system, it is difficult to exactly set the IUI to 0 in a TDD system.

It is evident from above that there is a need to consider the MU-MIMO transfer in an actual communication system, assuming that the IUI is present. Here, a difference in properties of the IUI between a non-linear pre-coding and a linear pre-coding is described. In the linear pre-coding, the current-time channel state information, the linear filter W, and the transmit data destined for a different terminal device 2 are included in the IUI. On the other hand, in the non-linear pre-coding, the perturbation term that is added to the transmit data destined for a different terminal device 2 is further added. Therefore, even though the pre-coding is set to be performed based on the same quantization channel matrix, average IUI power for the non-linear pre-coding is higher than for the linear pre-coding. For this reason, in a case where the number of feedback errors is great, transmission performance of the non-linear pre-coding is inferior to that of the linear pre-coding. An object of the present invention is to lessen degradation in the transmission performance of the non-linear pre-coding under such an environment.

A method of lessening the degradation in the transmission performance of the non-linear pre-coding according to the present embodiment will be described below. A difference with a method lessening the degradation in the transmission performance in the related art lies in signal processing in the perturbation vector search module 27-2 of the pre-coding module 27 of the base station device 1.

In the method in the related art, the perturbation vector search module 27-2 searches for a perturbation vector that satisfies Equation (4). At this time, as apparent from Equation (4), a perturbation term that is set to be a candidate by the perturbation vector search module 27-2 is an arbitrary Gaussian integer. For this reason, if the power normalization term β can be maximized, a significantly great value may be used for the perturbation term that is added to the transmit data destined for each of the terminal devices 2. However, the perturbation term that is added in this manner is already described as emphasizing the IUI that is observed in each of the terminal devices 2.

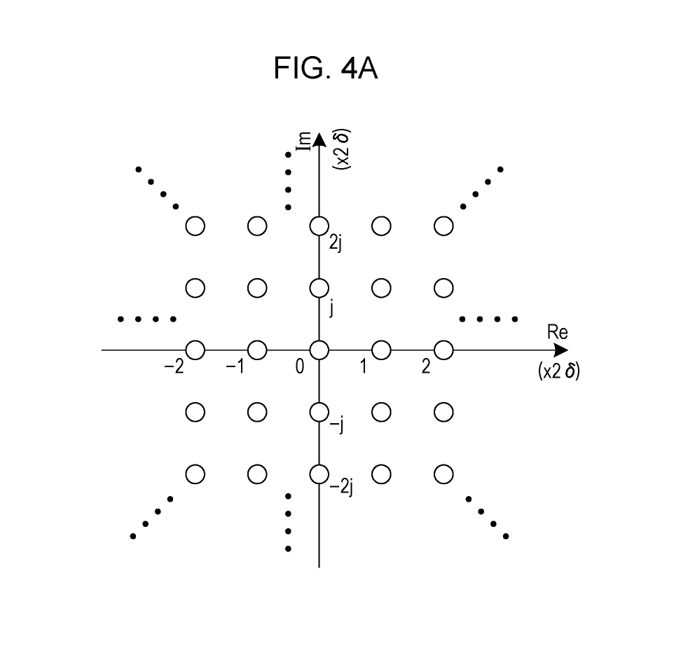

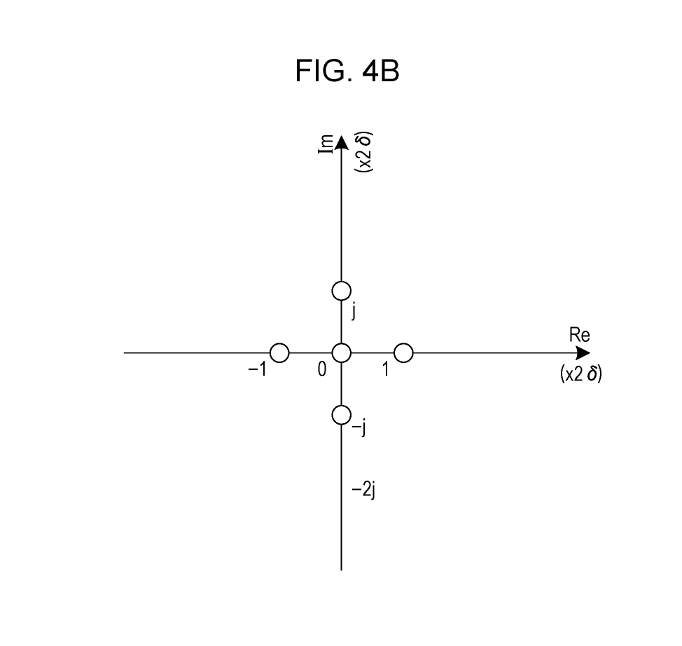

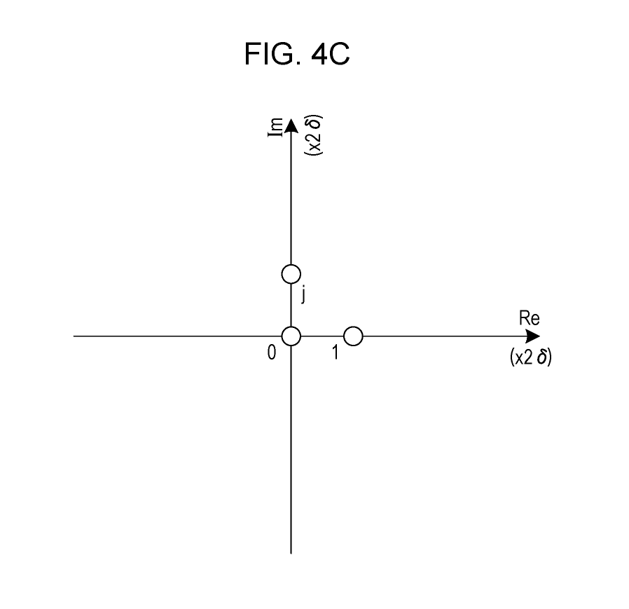

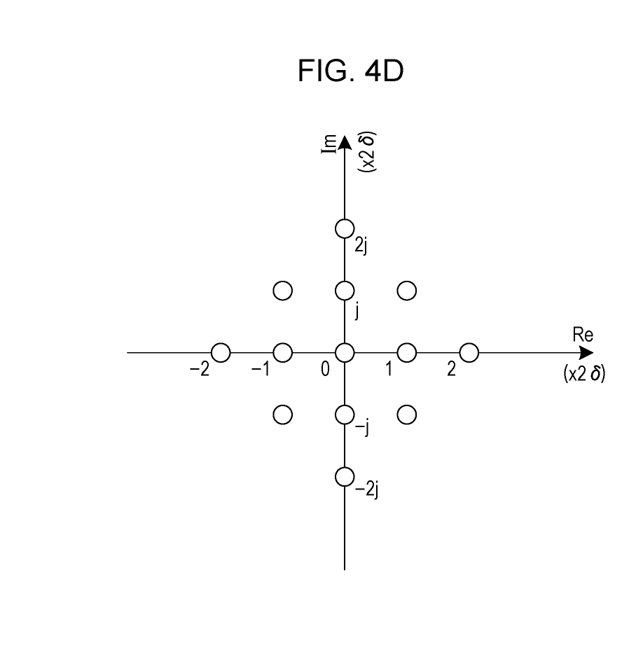

Accordingly, according to the present embodiment, a limitation is imposed on the perturbation term that can be set to be a candidate by the perturbation vector search module 27-2. FIGS. 4A to 4D are diagrams of a complex plane for describing the perturbation terms that are set to be candidates by the perturbation vector search module 27-2 according to the first embodiment of the present invention. FIG. 4A illustrates perturbation term candidates in the method in the related art, and candidate points (which are indicated by O in the drawings) are spread over the entire complex plane. FIG. 4B is a diagram illustrating one example of the perturbation term candidates according to the present embodiment. As illustrated in FIG. 4B, according to the present embodiment, the perturbation term candidates are only 5 points, that is, 2δ×{0, 1, j, −1, −j}, without spreading over the entire complex plane.

In a case where the perturbation vector search module 27-2 sets 5 points that are illustrated in FIG. 4B to be the perturbation term candidates, of course, a value of the power normalization term β is decreased when compared to a case of using the perturbation term candidates that are illustrated in FIG. 4A. To be more precise, a Signal-to-Noise power Ratio (SNR) is decreased. On the other hand, because the power for the perturbation term that is added to the transmit data destined for each of the terminal device 2 is decreased, the power for the IUI that is observed in each of the terminal device 2 can be decreased when compared to the method in the related art. To be more precise, a Signal-to-Interference power Ratio (SIR) is improved. Because actual transmission performance depends on a Signal-to-Interference plus Noise power Ratio (SINR), the most desirable technique is a technique that increases both of the SNR and the SIR. The imposition of the limitation on the number of the perturbation term candidates decreases the SNR while improving the SIR. However, in an environment where the feedback error is present, an influence of the SIR on the transmission performance is dominant. Therefore, the method according to the present embodiment can realize better transmission performance than the method in the related art.

A method of limiting the perturbation term candidate is not limited to the method in FIG. 4B. For example, as illustrated in FIG. 4C and FIG. 4D, a method of imposing a strict limitation on a perturbation term candidate point anew may be employed, or the limitation may imposed in such a manner that the number of perturbation term candidate points is somewhat increased. The number of perturbation term candidates is proportional to the SNR and is inversely proportional to the SIR. Therefore, in the perturbation vector search module 27-2 of the base station device 1, the number of perturbation term candidate points may be controlled in accordance with needed quality of a communication system. Association of the needed quality and the number of perturbation term candidate points with each other may be performed with computer simulation ahead of time.

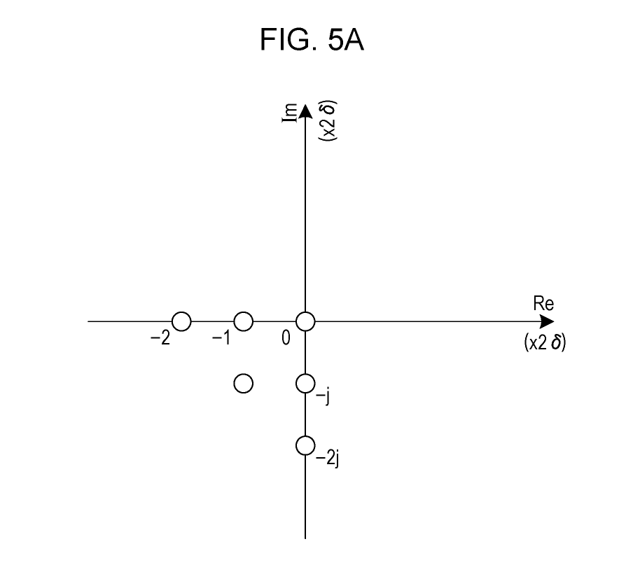

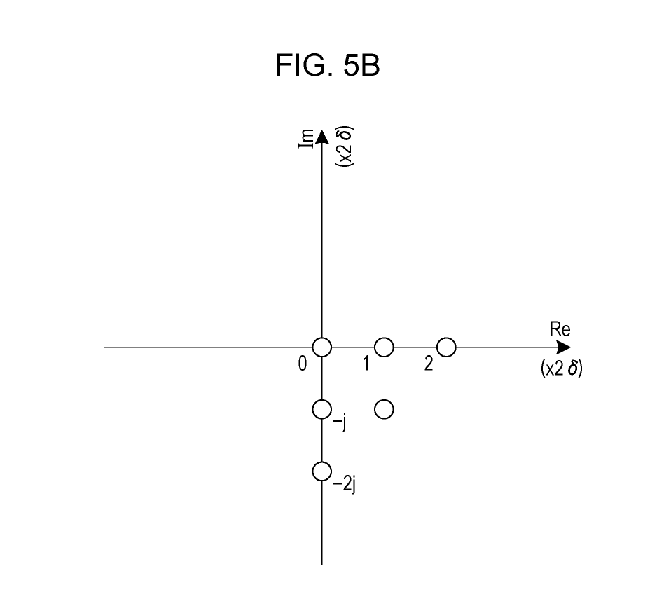

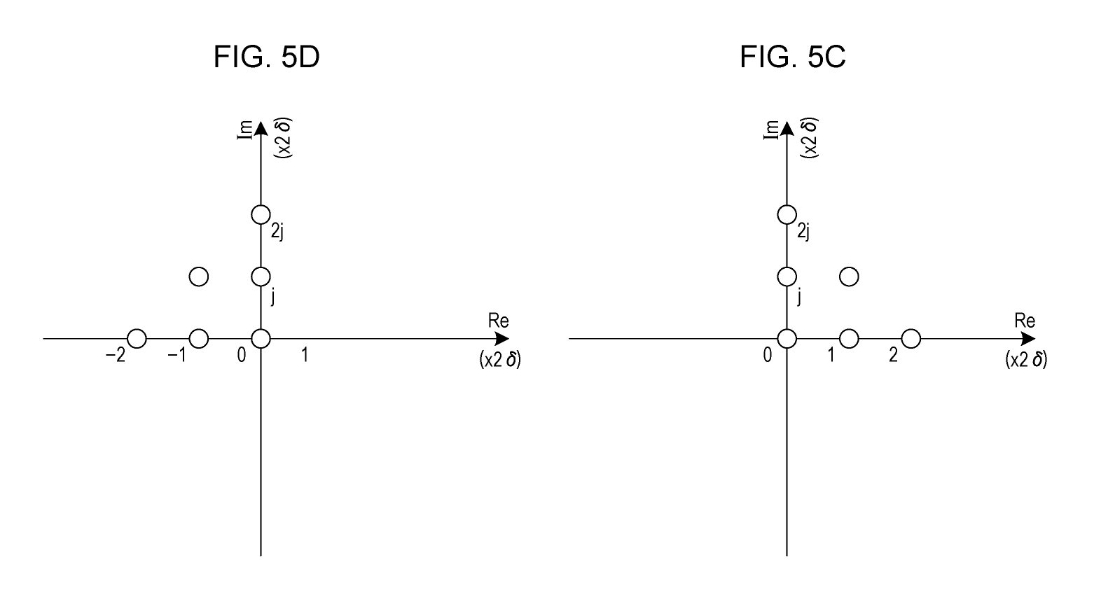

Furthermore, there is a method of imposing the limitation as illustrated in FIGS. 5A to 5D. FIGS. 5A to 5D are diagrams of another complex plane for describing the perturbation terms that are set to be candidates by the perturbation vector search module 27-2 according to the first embodiment of the present invention. Techniques in FIGS. 5A to 5D are ones in which the perturbation vector search module 27-2 changes the method of imposing the limitation on the perturbation term candidate in accordance with a quadrant in which the transmit data to which the perturbation term is added is present. FIGS. 5A, 5B, 5C, and 5D illustrate perturbation term candidate points in a case where the transmit data is present in a first quadrant, a second quadrant, a third quadrant, and a fourth quadrant, respectively. As is the case with FIGS. 4A to 4D, O indicates the perturbation term candidate point. For example, if the transmit data is present in the first quadrant, the perturbation term candidates are set to 2δ×{0, −1, −j, −1, −j, −2, −2j}, and if the transmit data is present in the second quadrant, the perturbation term candidates are set to 2δ×{0, 1, −j, 1−j, 2, −2j}. This is based on the fact that in a case where the power normalization term is intended to be maximized, the perturbation term that is added to the transmit data has the likelihood of being present in a quadrant that has point symmetry with respect to a quadrant in which the transmit data is present. With this method, as illustrated in FIGS. 4A to 4D, SNR can be less decreased when compared to a case where the limitation is simply imposed on the number of perturbation term candidates. As is the case with FIGS. 4A to 4D, the number of perturbation term candidates in each of the quadrants, may be determined in accordance with the needed quality and the like.

With the method described above, the perturbation vector search module 27-2 calculates a suitable perturbation vector, that is, 2δz=2δ [z₁, and so forth up to z_{U}]^{T}, and outputs a result of the calculation to the transmit signal generation module 27-3.

The transmit signal generation module 27-3 calculates a transmit signal vector s=W(d+2δz) based on the linear filter W that is calculated in the linear filter generation module 27-1, the perturbation vector 2δz that is calculated in the perturbation vector search module 27-2, and the transmit data vector d.

Moreover, as described above, the normalization of the transmit power is performed in every subcarrier, but the transmit signal generation module 27-3 may perform power normalization in such a manner that the transmit power for a sum of multiple subcarriers and OFDM signals is fixed. In this case, the perturbation vector search module 27-2 may search for the perturbation vector z, considering needed transmit power for the sum of multiple subcarriers and OFDM signals.

A transmit signal vector that is calculated in the transmit signal generation module 27-3 is input, as an output of the pre-coding module 27, into the antenna module 29. Moreover, in a case where the CSI-RS is input into the pre-coding module 27, only adjustment of the transmit power is performed without pre-coding processing being performed, and thus a result of the adjustment is output to the antenna module 29. On the other hand, in a case where the DMRS is input, the multiplication by the linear filter W is performed, and an addition of the perturbation term is not performed. At this time, it is desirable that the power normalization term β is set to be the same as that by which the data signal is multiplied. For this reason, the DMRS and the data signal on which the pre-coding is performed may be controlled in such a manner that the transmit power is normalized collectively.

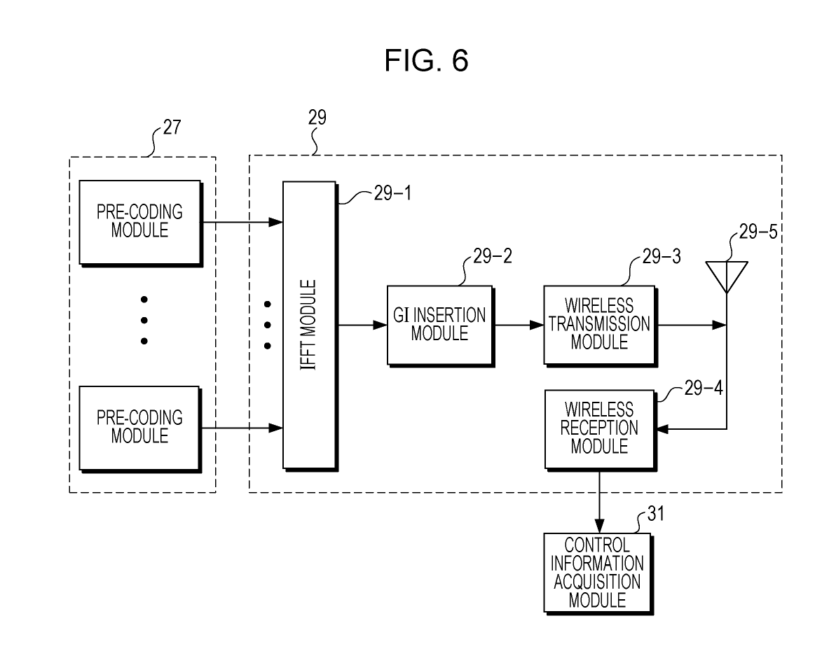

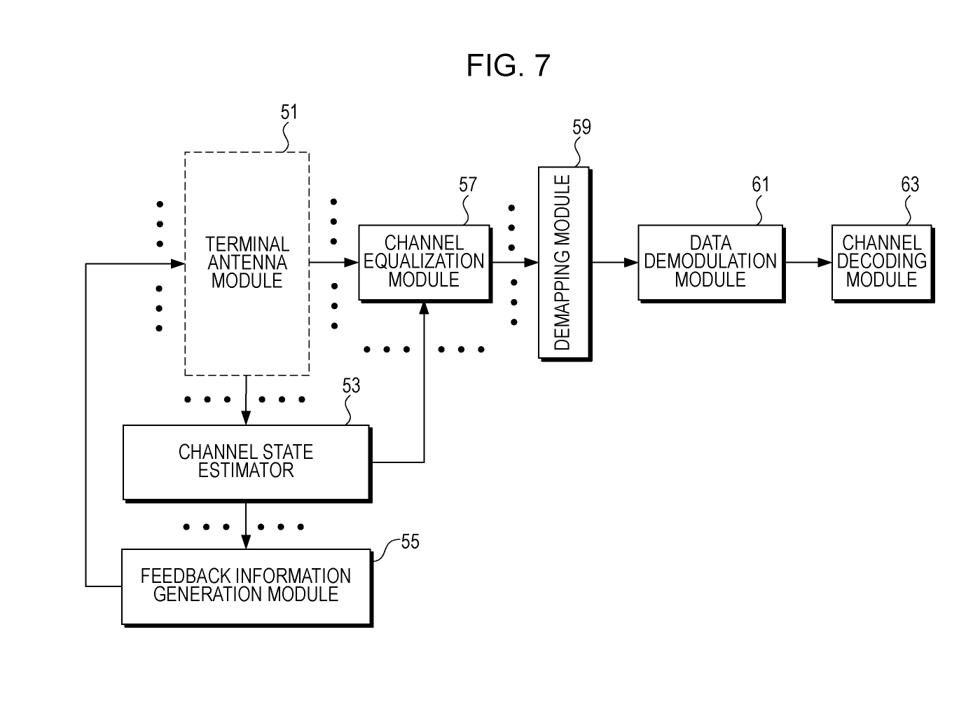

FIG. 6 is a block diagram illustrating a device configuration of the antenna module 29 according to the first embodiment of the present invention. As illustrated in FIG. 6, the antenna module 29 is configured to include an IFFT module 29-1, a GI insertion module 29-2, a wireless transmission module 29-3, a wireless reception module 29-4, and an antenna 29-5. In each antenna module 29, first, the IFFT module 29-1 applies N_{c} point inverse fast Fourier transform (IFFT) or inverse discrete Fourier transform (IDFT) to the signal that is output by the corresponding pre-coding module 27, generates an OFDM signal that has N_{c} subcarriers, and inputs the generated OFDM signal into the GI insertion module 29-2. Here, the number of subcarriers and the number of IFFT points are described as being the same, but in a case where a guard band is configured to be in a frequency domain, the number of points is greater than the number of subcarriers. The GI insertion module 29-2 assigns a guard interval to the OFDM signal being input and then inputs the resulting OFDM signal into the wireless transmission module 29-3. The wireless transmission module 29-3 converts a transmit signal in a baseband, which is input, into a transmit signal in a radio frequency (RF) band, and inputs the resulting transmit signal into the antenna 29-5. The antenna 29-5 transmits the transmit signal in the RF band being input.

[1.2 Terminal Device 2]

FIG. 7 is a block diagram illustrating a configuration of the terminal device 2 according to a first embodiment of the present invention. As illustrated in FIG. 7, the terminal device 2 is configured to include a terminal antenna module 51, a channel state estimator 53, a feedback information generation module 55, a channel equalization module 57, a demapping module 59, a data demodulation module 61, and a channel decoding module 63. Of these, the terminal antenna module 51 has the receive antennas of which the number is only Nᵣ. However, the u-th terminal device 2-u among the multiple terminal devices 2 that are connected to the base station device 1 is described below as being on focus with the number of receive antennas being set to Nᵣ=1, but the same signal processing is also applied to the other terminal devices 2.

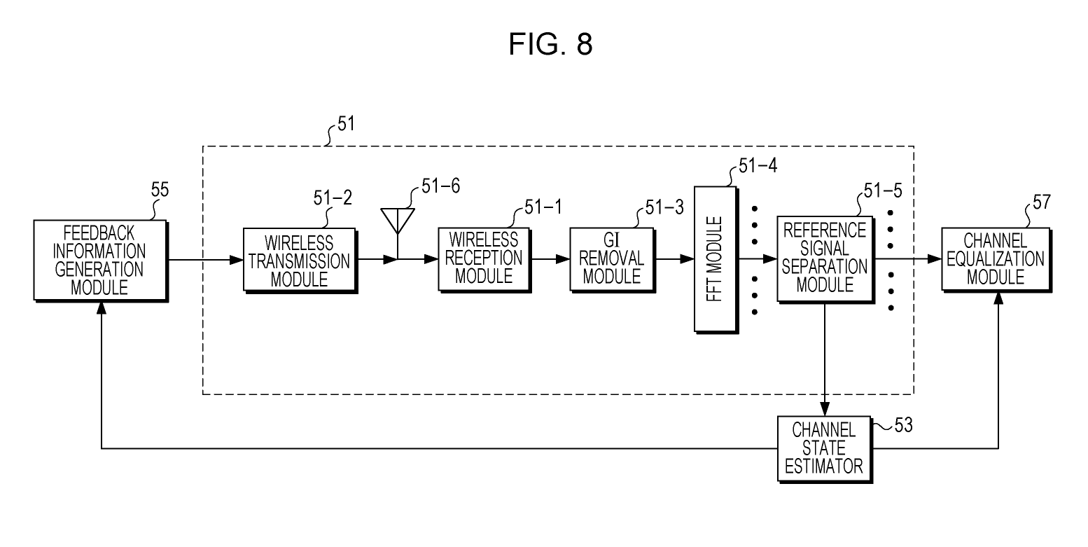

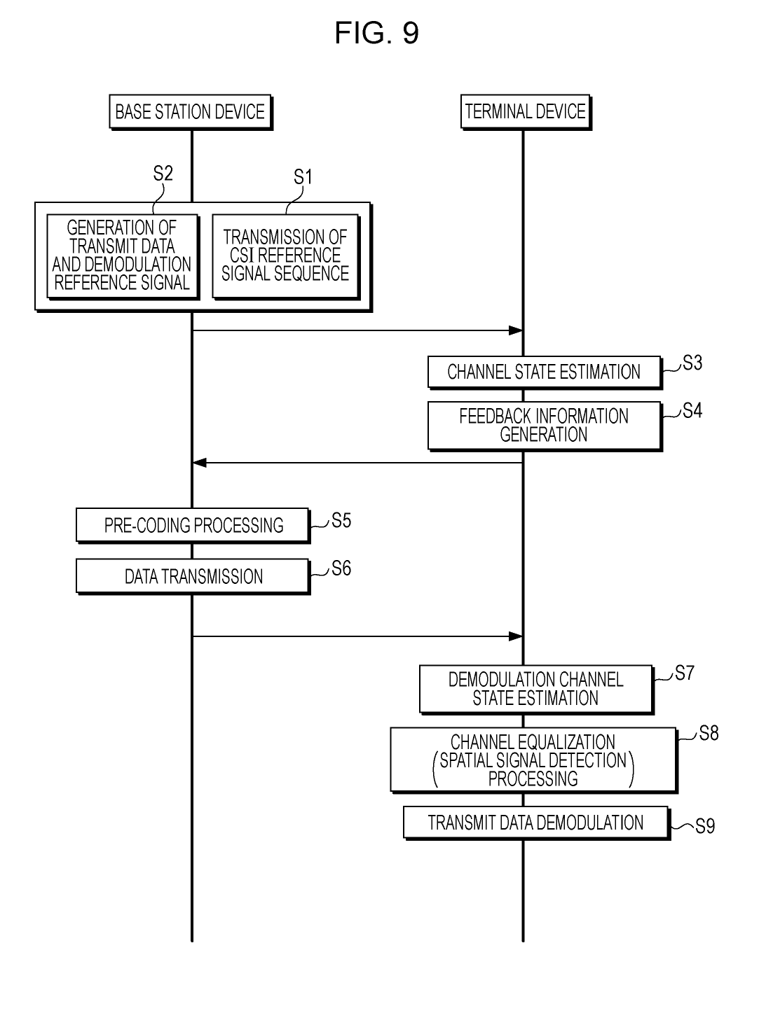

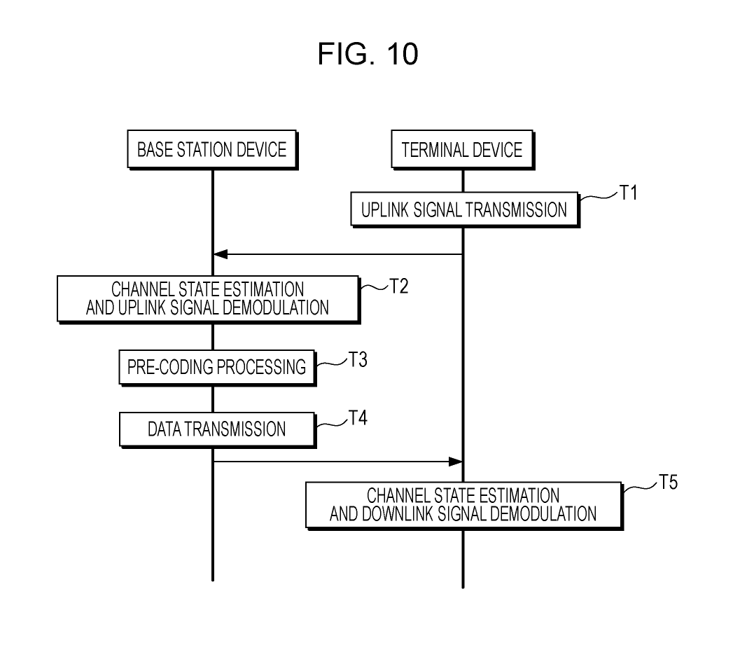

FIG. 8 is a block diagram illustrating a configuration of the terminal antenna module 51 according to the first embodiment of the present invention. As illustrated in FIG. 8, the terminal antenna module 51 is configured to include a wireless reception module 51-1, a wireless transmission module 51-2, a GI removal module 51-3, an FFT module 51-4, a reference signal separation module 51-5, and an antenna 51-6. A transmit signal that is transmitted by the base station device 1 is first received in the antenna 51-6 of the terminal antenna module 51, and then is input into the wireless reception module 51-1. The wireless reception module 51-1 converts the signal being input into a signal in a baseband, and inputs the resulting signal into the GI removal module 51-3. The GI removal module 51-3 removes the guard interval from the signal, which is input, and inputs the resulting signal into the FFT module 51-4. The FFT module 51-4 applies N_{c} point fast Fourier transform (FFT) or discrete Fourier transform (DFT) to the signal, which is input, converts the resulting signal into N_{c} subcarrier components, and then inputs a result of the conversion into the reference signal separation module 51-5. The reference signal separation module 51-5 separates the signal being input into a data signal component and a CSI-RS component, and a DMRS component. The reference signal separation module 51-5 inputs the data signal component into the channel equalization module 57, and inputs the CSI-RS and the DMRS into the channel state estimator 53. Signal processing is described below as being basically performed in every subcarrier.

Moreover, the CSI-RS and the DMRS are transmitted together. For brief description, a target for signal processing relating to the CSI-RS is set to be the CSI-RS that is received at the point in time t₁. Furthermore, as is the case with the data signal component, with regard to the DMRS, the DMRS that is received at the point in time t₂ is described.

The channel state estimator 53 performs channel estimation based on the CSI-RS and the DMRS that are already-known reference signals being input. First, the channel estimation that uses the CSI-RS which is received at the point in time t₁ is described. Because the CSI-RS is transmitted without the pre-coding being applied to it, it is possible to estimate a matrix hᵤ(k,t₁) that corresponds to the u-th terminal device 2-u, from a channel matrix H(k,t₁) that is expressed in Equation (1). Normally, because the CSI-RS's are periodically multiplexed onto the radio resources, the channel state information on all subcarriers is difficult to directly estimate. However, if the CSI-RS is transmitted at time intervals or at frequency intervals that satisfy a sampling theorem, with suitable interpolation, the terminal device 2 can estimate the channel state information on all subcarriers. A specific channel state estimation method is not particularly limited, but for example, two-dimensional MMSE channel state estimation may be used.

The channel state estimator 53 of the u-th terminal device 2-u inputs channel state information hᵤ(k,t₁) that is estimated based on the CSI-RS, into the feedback information generation module 55. The feedback information generation module 55 generates information, that is, h_{FB,u}(k,t₁), which is fed back to the base station device 1, in accordance with the channel state information being input and a channel state information format that is fed back by each of the terminal devices 2. According to the present invention, the channel state information format has no limitation whatsoever. For example, a method may be considered in which the quantization using a limited number of bits is performed on each component of the estimated channel state information hᵤ(k,t₁) and such quantization information is fed back. Furthermore, the feedback may be performed based on the code book that is determined in advance by the terminal device 2 and the base station device 1.

Furthermore, certain signal conversion may be performed and then the quantization may be performed without hᵤ(k,t₁) being directly quantized. For signal conversion, for example, a method of performing singular value decomposition may be considered. In this case, the feedback information generation module 55 quantizes an eigenvector obtained by the singular value decomposition, or both the eigenvector and a singular value, and thus generates information that is notified to the base station device 1.

Moreover, according to the present embodiment, all pieces of channel state information are set to use the channel state information in every subcarrier, that is, on the frequency domain. On the other hand, the feedback information generation module 55 may perform inverse discrete Fourier transform or inverse discrete cosine transform on the channel state information that is estimated in the frequency domain, thus may convert the resulting channel state information into channel state information on a time domain, and then may perform the quantization. Furthermore, the feedback information generation module 55 may perform control in such a manner that only one portion of the channel state information that is converted into the time domain is fed back.

Furthermore, in order to suppress the error due to temporal variation that is included in h_{FB,u}(k,t₁), based on multiple pieces of channel state information hᵤ(k,t) that are acquired before the point in time t₁, and based on the channel state information that is obtained by performing extrapolation, the feedback information generation module 55 may generate feedback information.

Furthermore, in a case where extrapolation is performed based on polynomial interpolation such as first-order linear prediction, a coefficient of a polynomial that is used in the interpolation may be set to be the feedback information. For example, in a case where the terminal device performs first-order linear prediction of channel state information H(t) at a point in time t, the terminal device performs the prediction based on a linear equation that is expressed as H(t)=A×t+B. At this point, based on a least squares method, a mean squared error minimizing method, or the like, A and B are calculated for every complex channel gain of each antenna and each discrete path. In this case, the feedback information generation module 55 may set A and B, which are calculated for every complex channel gain of each antenna and each discrete path, to be the feedback information.

Furthermore, prediction of the channel state information may be performed in the frequency domain. In this case, the terminal device may perform linear prediction in every subcarrier and may perform the linear prediction for every resource block into which multiple subcarriers are arranged. In this case, the terminal device also may set a coefficient of a polynomial that is used in the prediction, not the predicted channel state information itself, to be the feedback information.

As described above, it is possible for the terminal device to notify of various pieces of information as feedback information, but if a feedback information format is shared between the base station device and the terminal device, it is possible for the base station device to acquire channel information based on the information that is fed back.

The feedback information generation module 55 inputs the generated signal into the wireless transmission module 51-2 of the terminal antenna module 51. The wireless transmission module 51-2 converts the signal being input into a signal suitable for the transmission to the base station device 1 and inputs the resulting signal into the antenna 51-6 of the terminal antenna module 51. The antenna 51-6 of the terminal antenna module 51 transmits the signal being input to the base station device 1. Moreover, the channel state estimation that uses the DMRS will be described below.

Signal processing in the channel equalization module 57 is described. Now, when a data signal component of the k-th subcarrier that is received in the u-th terminal device 2-u at the point in time t₂ is set to be indicated by rᵤ(t₂), rᵤ(t₂) is given in Equation (6) (the subcarrier index k is omitted).

$$\begin{matrix} [ Math . 6 ] & \\ \begin{matrix}{r}_{u} ( t ) = {h}_{u} ( {t}_{2} ) W ( d ( {t}_{2} ) + 2 δ z ( {t}_{2} ) ) + {η}_{u} ( {t}_{2} ) \\ = {h}_{u} ( {t}_{2} ) {w}_{u} ( {d}_{u} ( {t}_{2} ) + 2 δ {z}_{u} ( {t}_{2} ) ) + {h}_{u} ( {t}_{2} ) {\sum }_{i = 1 , i \neq u}^{U} {w}_{i} ( {d}_{i} ( {t}_{2} ) + 2 δ {z}_{i} ( {t}_{2} ) ) + \\ {η}_{u} ( {t}_{2} )\end{matrix} & ( 6 )\end{matrix}$$

Descriptions of the data signal and the time index t₂ of the perturbation term are omitted below.

Channel time and frequency selectability have an influence on a desired signal (dᵤ+2δzᵤ), and thus a signal changes in amplitude and phase. For this reason, in order for the terminal device 2 to correctly demodulate the desired signal, channel equalization processing that removes this influence is needed. In order for the terminal device 2 to perform the channel equalization processing, a channel gain (hᵤ(t₂)×wᵤ) that has an influence on the signal amplitude and phase is needed.

Accordingly, in the channel state estimator 53, the channel state information for the channel equalization is estimated based on the DMRS that is transmitted at the point in time t₂. As is the case with the data signal, the DMRS is multiplied by the linear filter W and is transmitted, and moreover, the DMRS is transmitted with radio resources that are orthogonal to each other between the terminal devices. Therefore, by using the DMRS, it is possible for the u-th terminal device 2-u to estimate hᵤ(t₂)×wᵤ that is needed for the channel equalization. The channel state estimator 53 outputs the channel state information estimated based on the DMRS to the channel equalization module 57.

In the channel equalization module 57, the channel equalization is performed on the data signal component of the receive signal based on the channel state information hᵤ(t₂)×wᵤ that is needed for the channel equalization and that is input by the channel state estimator 53. As a channel equalization method, for example, the channel equalization as in Equation (7) may be performed.

$$\begin{matrix}[ Math . 7 ] & \\ \begin{matrix}{\hat{d}}_{u} = {r}_{u} ( {t}_{2} ) / {h}_{u} ( {t}_{2} ) {w}_{u} \\ = ( {d}_{u} + 2 δ {z}_{u} ) + \frac{{h}_{u} ( {t}_{2} )}{{h}_{u} ( {t}_{2} ) {w}_{u}} {\sum }_{i = 1 , i \neq u}^{U} {w}_{i} ( {d}_{i} + 2 δ {z}_{i} ) + \frac{1}{{h}_{u} ( {t}_{2} ) {w}_{u}} {η}_{u} ( {t}_{2} )\end{matrix} & ( 7 )\end{matrix}$$

In the channel equalization module 57, the modulo operation for removing the perturbation term from a receive signal d̂ᵤ after the channel equalization is furthermore performed. At this point, the modulo operation is signal processing that is given in Equation (8).

[Math. 8]

modulo_{2δ}(\hat{d}ᵤ)=\hat{d}ᵤ−2δ·floor(\hat{d}ᵤ/2δ+(1+j)/2) (8)

For an input, the modulo operation makes sizes of real and imaginary parts of an output greater than −8 and smaller than δ. Therefore, in a case where power of the remaining IUI and power of the noise are sufficiently low, the modulo operation can remove a perturbation term, of which real and imaginary parts are equal to or greater than 2δ in size. In the channel equalization module 57, a signal after the channel equalization and the modulo operation is output to the demapping module 59.

In the demapping module 59, the terminal device 2 extracts transmit data that is destined for the terminal device 2 itself, from radio resources that are used for transmission of the transmit data that is destined for the terminal device 2 itself. Moreover, a configuration may be employed in which an output from the reference signal separation module 51-5 is first input into the demapping module 59, and only components of radio resources that correspond to the terminal device to which the reference signal separation module 51-5 belongs are input into the channel equalization module 57. Thereafter, an output from the demapping module 59 is input into the data demodulation module 61 and the channel decoding module 63, and data demodulation and channel decoding are performed.

Moreover, with a method of performing the channel decoding, which is performed by the channel decoding module 63, it is also possible to directly perform decoding using a signal to which a perturbation term is added. In this case, in the channel equalization module 57, even though the modulo operation is not performed, this poses no problem.

Furthermore, in a case where the non-linear pre-coding is used, and in a case where the terminal device 2 obtains a logarithm likelihood ratio of the receive signal, a method in the related art assumes that all the perturbation terms occur with equal likelihood. On the other hand, according to the present embodiment, because there is a limitation to the perturbation term that can be selected by the base station device 1, the terminal device 2 may obtain the logarithm likelihood ratio considering only the perturbation term that has the likelihood of being selectable.

According to the present embodiment, OFDM signal transfer is assumed, and the pre-coding is assumed to be performed in every subcarrier, but there is no limitation to units for applying a transfer scheme (or an access scheme) or pre-coding. For example, it is also possible to apply the present embodiment to a case where the pre-coding is performed in every resource block into which multiple subcarriers are arranged, and in the same manner, it is also possible to apply the present embodiment to a single carrier-based access scheme (for example, a single-carrier frequency division multiple access (SC-FDMA) scheme and the like).

With the method described so far, in downlink MU-MIMO transfer that is based on the non-linear pre-coding, it is possible to suppress the remaining IUI that occurs due to a channel variation over time. Therefore, in an environment where it is difficult for the channel variation over time to be negligible, it is also possible to perform transfer without causing the transmission performance to be degraded greatly.

### 2. Second Embodiment

According to the first embodiment, the limitation is imposed on the number of perturbation term candidate points that the perturbation vector search module 27-2 of the base station device 1 searches for and thus a technique of suppressing the remaining IUI is made apparent. A second embodiment is for a method in which the limitation is imposed on a norm for selecting the perturbation term candidates and thus the remaining IUI occurring due to the feedback error is suppressed. According to the first embodiment and the second embodiment, there is no difference in device configuration between the base station device 1 and the terminal device 2, and a difference between them lies in signal processing in the perturbation vector search module 27-2 of the base station device 1.

[2.1 Signal Processing by the Perturbation Vector Search Module 27-2 of the Base Station Device 1]

According to the first embodiment, the perturbation vector is searched for by solving a problem of minimization that is expressed in Equation (4), provided that it is possible to select the perturbation term as is expressed in FIGS. 4A to 4D and 5A to 5D.

Incidentally, based on Equation (6), it is possible to calculate IUI power that is observed by the u-th terminal device 2-u, based on Equation (6), and the IUI power is expressed in Equation (9) (time index is omitted).

$$\begin{matrix}[ Math . 9 ] & \\ {‖ {h}_{u} {\sum }_{i = 1 , i \neq u}^{U} {w}_{i} ( {d}_{i} + 2 δ {z}_{i} ) ‖}^{2} = ‖ {h}_{u} ( {t}_{2} ) {( {W}_{u} ( d + 2 δ z ) ‖}^{2} \\ {W}_{u} = [ {w}_{1} , … , {w}_{u - 1} , 0 , {w}_{u + 1} , … , {w}_{U} ] & ( 9 )\end{matrix}$$

where Wᵤ is a matrix that results from substituting a zero vector in a u-th column of the linear filter W.

The IUI that is observed in the u-th terminal device 2-u can be minimized by minimizing Equation (9). Accordingly, in the perturbation vector search module 27-2 according to the second embodiment, the perturbation vector that minimizes Equation (9) is searched for.

Specifically, the perturbation vector that minimizes the IUI that is observed in the u-th terminal device 2-u satisfies Equation (10).

$$\begin{matrix}[ Math . 10 ] & \\ z = {argmin}_{\{ {z}_{j} ∈ Z [ i ] , j = 1 \sim U \}} {‖ {W}_{u} ( d + 2 δ z ) ‖}^{2} = {argmin}_{\{ {z}_{j} ∈ Z [ i ] , j = 1 \sim U \}} {α}_{u} \\ {α}_{u} = {‖ {W}_{u} ( d + 2 δ z ) ‖}^{2} & ( 10 )\end{matrix}$$

If the perturbation vector search module 27-2 searches for the perturbation vector that satisfies Equation (10), the IUI can be suppressed that is observed in the u-th terminal device 2-u. However, the IUI that is observed in the terminal devices 2 other than the u-th terminal device 2-u is not suppressed. Accordingly, according to the present embodiment, the perturbation vector search module 27-2 of the base station device 1 searches for the perturbation vector that suppresses average power of the IUI that is observed in each of the terminal devices 2. Specifically, the perturbation vector search module 27-2 searches for the perturbation vector that satisfies Equation (11).

$$\begin{matrix}[ Math . 11 ] & \\ Z = {argmin}_{\{ {z}_{j} ∈ Z [ i ] , j = 1 \sim U \}} {\sum }_{u = 1}^{U} {α}_{u} & ( 11 )\end{matrix}$$

The perturbation vector search module 27-2 searches for the perturbation vector that satisfies Equation (11), and thus it is possible to suppress the average power of the IUI that is observed in each of the terminal devices 2. Moreover, as expressed in Equation (10), if the perturbation vector search module 27-2 is controlled in such a manner that only the IUI that is observed in an arbitrary terminal device 2 is suppressed, this poses no problem. Furthermore, even if control is performed in such a manner that average power of the IUI of arbitrary multiple terminal devices 2, not of all terminal devices 2, is suppressed, this poses no problem. At this time, the terminal device 2 that suppresses the IUI may be periodically switched in the time and frequency domains. For example, even if control is performed in such a manner that the perturbation vector search module 27-2 suppresses the IUI of a first terminal device 2-1 at a point in time t₃, and suppresses the IUI of a second terminal device 2-2 at a point in time t₄, this poses no problem.

Moreover, according to the present embodiment, there is no need to impose a limitation on the candidate point of the perturbation term that is added to the transmit data destined for each of the terminal devices 2. This distinguishes the present embodiment from the first embodiment that imposes the limitation on the number of the perturbation term candidate points. However, of course, even if according to the present embodiment, the limitation is imposed on the number of the perturbation term candidate points, as is the case with the first embodiment, this poses no problem.

Furthermore, the base station device 1 may perform control in such a manner that in accordance with a coding rate, a modulation level, or the like, a method (a first method) according to the first embodiment and a method (a second method) according to the second embodiment are used at the same time or selectively. Additionally, in addition to a method in the related art, which does not impose a limitation on the number of the perturbation term candidate points or the norm for searching for the perturbation term, these methods may be controlled in such a manner that they are used at the same time or selectively. Furthermore, based on the transmit power or on the channel state information that is notified by each of the terminal devices 2, the base station device 1 may use the first method and the second method at the same time or selectively. For example, control may be performed in such a manner that in a case where from the channel state information, it is assumed that the inter-user interference is high, the second method is used and in such a manner that in a case where from the channel state information, it is assumed that the inter-user interference is not so high, the first method is used.

Because the inter-user interference that occurs due to the feedback error can be suppressed with the method according to the second embodiment, the spectral efficiency of non-linear MU-MIMO can be improved.

### 3. Third Embodiment

According to the first and second embodiments, the limitation is imposed on the number of the perturbation term candidate points or the norm for selecting the perturbation vector, and thus the IUI that is observed in each of the terminal devices is suppressed. Incidentally, according to the first and second embodiments, it is assumed that statistical properties of the feedback error that is present between channel state information h_{FB,u}(k,t₁) that is notified by each of the terminal devices 2 to the base station device 1 and actual channel state information hᵤ(k,t₂) are the same in all the terminal devices 2. At this point, for example, a situation in which all the terminal devices 2 calculate h_{FB,u}(k,t₁) based on the same channel state information format, or a situation in which moving speeds of all the terminal devices 2 are the same falls within the scope of the situation where the statistical properties of the feedback error are the same. The third embodiment is for a situation where the statistical properties of the feedback error vary from one terminal device 2 to another.

[3.1 Terminal Device 2]

A device configuration of the terminal device 2 according to the third embodiment is the same as those according to the first and second embodiments. A difference lies in only signal processing in the feedback information generation module 55. Therefore, only the signal processing in the feedback information generation module 55 of the terminal device 2 is described below.

In the feedback information generation module 55, two pieces of information are generated. As is the case with the first and second embodiments, one is the channel state information h_{FB,u}(k,t₁) that is calculated based on the channel state information hᵤ(k,t₁) between the base station device 1 and the terminal device and that is notified to the base station device 1. Because a method of calculating h_{FB,u}(k,t₁) is the same as that according to the first and second embodiments, a description thereof is omitted.

The two pieces of information that are generated by the feedback information generation module 55 are pieces of information that are associated with the feedback error between the channel state information h_{FB,u}(k,t₁) and the actual channel state information hᵤ(k,t₁) or hᵤ(k,t₂). At this point, the pieces of information that are associated with the error are pieces of information with which it is possible for the base station device 1 to recognize a size of the feedback error that is included in h_{FB,u}(k,t₁) which can be actually recognized by the base station device 1. For example, a method of notifying a normalized mean squared error between hᵤ(k,t)₁ and h_{FB,u}(k,t₁) may be considered. If the normalized mean squared error is large, there is a likelihood that the base station device 1 will determine that the feedback error of h_{FB,u}(k,t₁) is large. Furthermore, a method of notifying the base station device 1 of the moving speed of the terminal device 2 may be considered. Because it is possible for the terminal device 2 to estimate a maximum Doppler frequency from a frequency spectrum of the receive signal that is received in the terminal device 2 itself, the terminal device 2 may notify the base station device 1 of the maximum Doppler frequency. In this case, it is possible for the base station device 1 to determine that the feedback error is large in the terminal device 2 in which the maximum Doppler frequency is large. The reason for this is that in a case where the moving speed is high, the error due to the temporal variation is large.

Furthermore, a method of notifying information relating to the channel state information format that is used when the terminal device 2 calculates h_{FB,u}(k,t₁) may also be considered. For example, in a case where, starting from hᵤ(k,t₁), the quantization is performed on h_{FB,u}(k,t₁), the greater the number of quantization bits, the smaller the feedback error of h_{FB,u}(k,t₁). On the other hand, because an amount of information relating to the notification of h_{FB,u}(k,t₁) is increased, the number of quantization bits needs to be optimized in accordance with needed communication quality or an allowed amount of information. Accordingly, even if the terminal device 2 sets the number of quantization bits to be information associated with the feedback error, this poses no problem.

Furthermore, a case also may be considered where the terminal device 2 notifies of h_{FB,u}(k,t₁) in a resource block unit that is configured from multiple subcarriers without h_{FB,u}(k,t₁) of all the subcarriers being notified. In this case, in a case where the number of subcarriers that construct one resource block is great, or in a case where the notification is performed in units of multiple resource blocks, the error that is included in h_{FB,u}(k,t₁) is large. Therefore, the feedback information generation module 55 of the terminal device 2 may output the number of subcarriers that construct the resource block or the number of resource blocks as information associated with the error.

Furthermore, even if the feedback information generation module 55 sets the accuracy with which hᵤ(k,t₁) is estimated, not the channel state information format on which h_{FB,u}(k,t₁) is based, to be information that is associated with the feedback error, this poses no problem. For example, because the accuracy with which hᵤ(k,t₁) is estimated is determined in accordance with receive power of the reference signal (CSI-RS), the feedback information generation module 55 may output the receive power of the CSI-RS as information that is associated with the feedback error.

Based on the method described so far, the feedback information generation module 55 of the terminal device 2 generates the information associated with the feedback error of h_{FB,u}(k,t₁), and outputs the resulting information to the wireless transmission module 51-2 of the terminal antenna module 51. Moreover, signal processing in a different constituent device of the terminal device 2 is the same as those according to the first and second embodiments, and a description thereof is omitted.

[3.2 Base Station Device 1]

A device configuration of the base station device 1 according to the third embodiment is the same as those according to the first and second embodiments. A difference lies in signal processing of each of the control information acquisition module 31, the channel state information acquisition module 33, and the pre-coding module 27. First, the signal processing in each of the control information acquisition module 31 and the channel state information acquisition module 33 is described. First, as is the case with the first and second embodiment, the control information acquisition module 31 acquires pieces of control information that are notified by the terminal devices 2 in a connected state, and outputs information associated with the channel state information, among the pieces of control information, to the channel state information acquisition module 33. Moreover, the control information acquisition module 31 acquires the information that is notified by each of the terminal devices 2 and that is associated with the feedback error of h_{FB,u}(k,t₁), from the control information, and outputs the resulting information to the channel state information acquisition module 33.

First, as is the case with the first and second embodiments, in the channel state information acquisition module 33, based on information being input from the control information acquisition module 31, h_{FB,u}(k,t₁) that is notified from each of the terminal devices 2 is acquired. Then, the channel matrix H_{FB}(k,t₁) that is expressed in Equation (2) is calculated based on h_{FB,u}(k,t₁). Subsequently, in the channel state information acquisition module 33, the information associated with the feedback error of h_{FB,u}(k,t₁) is acquired, and the feedback error of h_{FB,u}(k,t₁) that is notified by each of the terminal devices 2 in the connected state is acquired. The normalized mean squared error between h_{FB,u}(k,t₁) and hᵤ(k,t₁) is described below as being notified as the information associated with the feedback error. Then, the normalized mean squared error that is notified by the u-th terminal device 2-u is defined as eᵤ. In this case, the terminal device 2 that has a large eᵤ is set to have a large feedback error of h_{FB,u}(k,t₁).

Even in a case where information other than the normalized mean squared error is notified, a size of the feedback error of h_{FB,u}(k,t₁) is set to be expressed as eᵤ. For example, in a case where each of the terminal devices 2 notifies the moving speed, the moving speed, as is, may be input into eᵤ. Furthermore, in a case where each of the terminal devices 2 notifies the number of quantization bits, a reciprocal of the number of quantization bits may be input into eᵤ. As described above, if information with which it is possible for the base station device 1 to determine that the feedback error of h_{FB,u}(k,t₁) is large when its value is large is input into eᵤ, this is sufficient.

In the channel state information acquisition module 33, the quantization channel matrix H_{FB}(k,t₁) and error information {eᵤ; u=1 to U} of each of the terminal devices 2 are output to the pre-coding module 27.

Last, the signal processing in the pre-coding module 27 according to the third embodiment is described. Because the first and second embodiments are almost the same in device configuration, a description is provided referring to FIG. 3. However, an output of the channel state information acquisition module 33 is input not only in the linear filter generation module 27-1, but also in the perturbation vector search module 27-2.

In the pre-coding module 27, the signal processing in each of the linear filter generation module 27-1 and the transmit signal generation module 27-3 is the same as those according to the first and second embodiments. On the other hand, in the perturbation vector search module 27-2, the perturbation vector is searched for based on the error information {eᵤ; u=1 to U} that is input by the channel state information acquisition module 33 in addition to the linear filter W that is input from the linear filter generation module 27-1 and the transmit data vector d(k,t₂) that is input by the mapping module 25.

In the perturbation vector search module 27-2, in basically the same manner as in the related art, the perturbation vector that can minimize the needed transmit power is searched for, but in accordance with a value of the error information {eᵤ; u=1 to U} that is input, a limitation is imposed on the number of perturbation term candidate points or the norm for searching for the perturbation term.

Basically, in accordance with the error information that is notified by each of the terminal devices 2, the perturbation vector search module 27-2 determines the terminal device 2 that has to preferentially suppress the IUI. Then, based on such a determination, the perturbation vector search module 27-2 searches for the perturbation vector.

As one actual search method, there is a method in which the number of perturbation term candidate points that is added to the transmit data of each of the terminal devices 2 is made to be proportional to a size of the error information {eᵤ; u=1 to U}. That is, while the number of perturbation term candidate points for the terminal device 2 that has a large amount of error information is increased, the number of perturbation term candidate points for the terminal device 2 that has a small amount of error information is decreased. Because the perturbation term that is added to the transmit data destined for a different terminal device 2 has an influence on the IUI that is observed in each of the terminal devices 2, it is possible to suppress the IUI by imposing the limitation on a size of the perturbation term that is added to the transmit data destined for a terminal device 2 other than the terminal device 2 that has a large amount of error information. However, in a case where the number of the terminal devices each of which has a large amount of error information, with this method, an excessively great performance improvement effect is not expected.

In a case where multiple terminal devices 2 each of which has a large amount of error information are present, based on an average value of the error information {eᵤ; u=1 to U}, the limitation may be imposed on the number of perturbation term candidate points for all the terminal devices 2. Moreover, in order to determine a size of the error information, a certain threshold is defined, and the size of the error information may be determined based on a relation in size between the threshold and eᵤ. A size of the threshold may be determined with computer simulation ahead of time.

Furthermore, in accordance with the size of the error information {eᵤ; u=1 to U}, it is possible to impose the limitation on the norm for searching for the perturbation term. For example, under the situation where the terminal devices 2 of which the number is U=4 are connected at the same time, in a case where pieces of error information e₁ and e₂ that are notified by the first and second terminal devices 2-1 and 2-2 are large, the perturbation vector search module 27-2 searches for the perturbation vector based on Equation (12).

$$\begin{matrix}[ Math . 12 ] & \\ z = {argmin}_{\{ {z}_{j} ∈ Z [ i ] , j = 1 \sim U \}} ( {α}_{1} + {α}_{2} ) & ( 12 )\end{matrix}$$

A norm for searching for the perturbation vector in Equation (12) is different from the norm (Equation (11)) for searching for the perturbation vector that is used according to the second embodiment, and is a norm for suppressing the IUI that is observed in each of the first and second terminal devices 2-1 and 2-2. To be more precise, while according to the second embodiment, the IUI that is observed in each of all the terminal devices 2 is suppressed on average, Equation (12) serves a purpose of suppressing only the IUI that is observed in the terminal device 2 that has a large amount of error information. The reason for this is that, in the first place, the IUI that is observed in the terminal device 2 that has a small amount of error information is small.

In Equation (12), the multiple terminal devices 2 that are connected to the base station device 1 are divided into two groups: one group to which the terminal device 2 that suppresses the IUI belongs and another group to which the terminal device 2 that does not suppress the IUI belongs.

Then, the perturbation vector search module 27-2 searches for the perturbation vector. On the other hand, because the IUI that is observed in the u-th terminal device 2-u depends on a size of αᵤ, even if as expressed in Equation (13), suitable weighting is applied to αᵤ and a norm for searching the perturbation vector is set to be established, this poses no problem.

$$\begin{matrix}[ Math . 13 ] & \\ z = {argmin}_{\{ {z}_{j} ∈ Z [ i ] , j = 1 \sim U \}} {\sum }_{u = 1}^{U} {e}_{u} {α}_{u} & ( 13 )\end{matrix}$$

That is, the perturbation vector search module 27-2 preferentially suppresses the IUI that is observed in the terminal device 2 that has a large amount of error information. A method of applying weighting to αᵤ is not limited to Equation (13), and the weighting may be applied based on a squared value or a square root of eᵤ, or the like. Moreover, because signal processing of another constituent device of the base station device 1 is the same as those according to the first and second embodiments, a description thereof is omitted.

Incidentally, the error that is included in h_{FB,u}(k,t₁) is described above as being assumed to be notified by each of the terminal devices 2. On the other hand, it is also possible for the base station device 1 to independently estimate error information without each of the terminal device 2 notifying the error information.

As a method of estimating the error information, there is a method in which the base station device 1 estimates a maximum Doppler frequency from an uplink signal that is transmitted from each of the terminal devices 2. It is possible for the base station device 1 to obtain an autocorrelation function based on a reference signal and the like that are included in an uplink signal that is transmitted from each of the terminal devices 2. Therefore, with the autocorrelation function, it is possible to estimate the maximum Doppler frequency, that is, the moving speed, which is observed in each of the terminal devices 2. In this case, the base station device 1 may use the estimated moving speed as the error information. This is also possible in a wireless communication system that is based on the TDD system.

Furthermore, the base station device 1 designates the channel state information format that is used when calculating h_{FB,u}(k,t₁) for each of the terminal devices 2, and thus the error information can be recognized. For example, in a communication system in which the base station device 1 designates the number of quantization bits for each of the terminal devices 2, the base station device 1 may use a reciprocal of the number of quantization bits that is designated for each of the terminal devices 2, as the error information.

Furthermore, a method of determining the error information in accordance with needed quality of each of the terminal devices 2 may also be considered. This method is for a communication system in which an adaptive modulation technology that adaptively configures a modulation scheme or a coding rate is used in accordance with transfer quality. Normally, in a case where the number of many values is great or in a case where the coding rate is high, in short, the higher the spectral efficiency is, the greater the tendency for being influenced. Accordingly, by determining whether or not the terminal device 2 in which the transmission scheme with high spectral efficiency is configured is the terminal device 2 that has a large amount of error information, it is possible for the base station device 1 to suppress the IUI that is observed by the terminal device 2 in which the transmission scheme with high spectral efficiency is configured. This is also possible in the wireless communication system that is based on the TDD system.

With the method described so far, in accordance with the size of the IUI that is observed in each of the terminal devices 2, in the perturbation vector search module 27-2 of the base station device 1, it is possible to search for a suitable perturbation vector.

(1) Furthermore, it is possible for the present embodiment to employ the following aspects. That is, according to an embodiment, there is provided a base station device, which includes multiple antennas and which performs non-linear pre-coding and spatial multiplexing on signals destined for multiple terminal devices and thus performs wireless communication, the base station device including: a channel state information acquisition module that acquires channel state information between the base station device and the terminal device; a perturbation vector search module that searches for a perturbation vector which is received by each of the multiple terminal devices and which suppresses inter-user interference, using a linear filter that is generated based on the channel state information; and a transmit signal generation module that calculates a transmit signal vector based on the generated linear filter, the perturbation vector and a transmit data vector.

In this manner, because the base station device includes the channel state information module that acquires the channel state information between the base station device and the terminal device, the perturbation vector search module that searches for the perturbation vector which is received by each of the multiple terminal devices and which suppresses the inter-user interference, using the linear filter that is generated based on the channel state information, and the transmit signal generation module that calculates the transmit signal vector based on the generated linear filter, the perturbation vector and the transmit data vector, in the wireless communication system that performs the non-linear pre-coding, this can cause degradation in the transmission performance due to the feedback error to be lessened and can contribute to considerable improvement in the spectral efficiency.

(2) Furthermore, in the base station device according to the present embodiment, the perturbation vector search module performs a first method in which perturbation term candidate points that are expressed using Gaussian integers of which the number is determined in advance are searched for the perturbation vector, or a second method in which the perturbation vector that is received by at least one terminal device among the multiple terminal devices and that suppresses the inter-user interference is searched for.

In this manner, because the perturbation vector search module performs the first method in which the perturbation term candidate points that are expressed using the Gaussian integers of which the number is determined in advance are searched for the perturbation vector, or the second method in which the perturbation vector that is received by at least one terminal device among the multiple terminal devices and that suppresses the inter-user interference is searched for, it is possible to suppress the remaining IUI that occurs due to the channel variation over time in the downlink MU-MIMO transfer that is based on the non-linear pre-coding. Therefore, in an environment where it is difficult for the channel variation over time to be negligible, it is also possible to perform transfer without causing the transmission performance to be degraded greatly. Furthermore, because the inter-user interference that occurs due to the feedback error can be suppressed, the spectral efficiency of non-linear MU-MIMO can be improved.

(3) Furthermore, in the base station device according to the present embodiment, based on at least one among a modulation scheme, a coding rate, and the channel state information, which are applied to the signals, the perturbation vector search module uses the first method or the second method at the same time or selectively.

In this manner, because, based on at least one among a modulation scheme, a coding rate, and the channel state information, which are applied to the signals, the perturbation vector search module uses the first method or the second method at the same time or selectively, in the downlink MU-MIMO transfer that is based on the non-linear pre-coding, it is possible to suppress the remaining IUI that occurs due to the channel variation over time. Therefore, in the environment where it is difficult for the channel variation over time to be negligible, it is also possible to perform the transfer without causing the transmission performance to be degraded greatly. Furthermore, because the inter-user interference that occurs due to the feedback error can be suppressed, the spectral efficiency of non-linear MU-MIMO can be improved.

(4) Furthermore, in the base station according to the present embodiment, in time or frequency domains, the perturbation vector search module periodically allocates the terminal device that suppresses the inter-user interference, among the multiple terminal devices.

In this manner, because in time or frequency domains, the perturbation vector search module periodically allocates the terminal device that suppresses the inter-user interference, among the multiple terminal devices, the inter-user interference that occurs due to the feedback error can be suppressed, and the spectral efficiency of non-linear MU-MIMO can be improved.

(5) Furthermore, in the base station device according to the present embodiment, the channel state information acquisition module acquires first channel state information based on control information associated with the first channel state information that is notified by each of the multiple terminal devices, and acquires error information between the first channel state information and the control information or error information between the first channel state information and second channel state information on a channel on which the signals are propagated as wireless signals based on the first channel state information.

In this manner, because the channel state information acquisition module acquires the first channel state information based on the control information associated with the first channel state information that is notified by each of the multiple terminal devices, and acquires the error information between the first channel state information and the control information or error information between the first channel state information and the second channel state information on a channel on which the signals are propagated as the wireless signals based on the first channel state information, it is possible to search for a suitable perturbation vector in the perturbation vector search module of the base station device in accordance with a size of the IUI that is observed in each of the terminal devices.

(6) Furthermore, in the base station device according to the present embodiment, the channel state information acquisition module acquires first channel state information based on control information associated with the first channel state information that is notified by each of the multiple terminal devices, and acquires error information between the first channel state information that is notified by each of the multiple terminal devices and the control information or error information between the first channel state information and second channel state information on a channel on which the signals are propagated as wireless signals.

In this manner, because the channel state information acquisition module acquires the first channel state information based on the control information associated with the first channel state information that is notified by each of the multiple terminal devices, and acquires the error information between the first channel state information that is notified by each of the multiple terminal devices and the control information or error information between the first channel state information and the second channel state information on the channel on which the signals are propagated as the wireless signals, it is possible to search for a suitable perturbation vector in the perturbation vector search module of the base station device in accordance with a size of the IUI that is observed in each of the terminal devices.

(7) In the base station device according to the present embodiment, based on the first channel state information and the error information, non-linear pre-coding is performed on the signals.

In this manner, because based on the first channel state information and the error information, the base station device performs the non-linear pre-coding on the signals, in accordance with the size of the IUI that is observed in each of the terminal device, in the perturbation vector search module of the base station device, it is possible to search for a suitable perturbation vector.

(8) Furthermore, in the base station device according to the present embodiment, the perturbation vector search module searches for the perturbation vector that is received by the terminal device which has a large amount of error information, and that suppresses the inter-user interference.

In this manner, because the perturbation vector search module searches for the perturbation vector that is received by the terminal device which has the large amount of error information, and that suppresses the inter-user interference, in accordance with the size of the IUI that is observed in each of the terminal device, in the perturbation vector search module of the base station device, it is possible to search for a suitable perturbation vector.

(9) Furthermore, according to an embodiment, there is provided a terminal device that receives wireless signals on which non-linear pre-coding and spatial multiplexing are performed from a base station device that includes multiple antennas, the terminal device including: a reference signal separation module that separates a data signal and a reference signal from each of the wireless signals; a channel state estimator that estimates first channel state information between the base station device and the terminal device based on the reference signal; a feedback information generation module that generates control information associated with the first channel state information that is notified to the base station device, from the first channel state information; and a wireless transmission module that transmits the control information to the base station device, in which the feedback information generation module generates error information between the first channel state information and the control information.

In this manner, because the terminal device includes the feedback information generation module that generates control information associated with the first channel state information that is notified to the base station device, from the first channel state information and the wireless transmission module that transmits the control information to the base station device, in which the feedback information generation module generates error information between the first channel state information and the control information, it is possible to search for a suitable perturbation vector in the perturbation vector search module of the base station device in accordance with the size of the IUI that is observed in each of the terminal devices.

(10) Furthermore, in the terminal device according to the present embodiment, the feedback information generation module generates error information between second channel state information between the terminal device and the base station device on which the data signal that is received at a first point in time or on a first frequency is propagated, and the first channel state information that is estimated based on the reference signal that is received at a second point in time or on a second frequency.

In this manner, because the feedback information generation module generates the error information between the second channel state information between the terminal device and the base station device on which the data signal that is received at the first point in time or on the first frequency is propagated, and the first channel state information that is estimated based on the reference signal that is received at the second point in time or on the second frequency, it is possible to search for a suitable perturbation vector in the perturbation vector search module of the base station device in accordance with the size of the IUI that is observed in each of the terminal devices.

(11) Furthermore, according to an embodiment, there is provided a wireless communication system including: the base station device according to (1); and the multiple terminal devices according to (9).

In this manner, because the base station device includes the channel state information acquisition module that acquires the channel state information between the base station device and the terminal device, the perturbation vector search module that searches for the perturbation vector which is received by each of the multiple terminal devices and which suppresses the inter-user interference, using the linear filter that is generated based on the channel state information, and the transmit signal generation module that calculates the transmit signal vector based on the generated linear filter, the perturbation vector and the transmit data vector, in the wireless communication system that performs the non-linear pre-coding, this can cause degradation in the transmission performance due to the feedback error to be lessened and can contribute to the considerable improvement in the spectral efficiency.

[4. Common to all Embodiments]

The embodiments according to the present invention are described above in detail referring to the drawings, but the specific configuration is not limited to the embodiments and a design and the like within a scope not deviating from the gist of the present invention fall within a scope of claims.

Moreover, the present invention is not limited to the embodiments described above. Furthermore, application of the terminal device 2 according to the present invention is not limited to mobile station devices such as a cellular system. It goes without saying that the terminal device 2 can be applied to a stationary-type electronic apparatus that is installed indoors or outdoors, or a non-movable-type electronic apparatus, for example, an AV apparatus, a kitchen apparatus, a cleaning or washing machine, an air-conditioning apparatus, office equipment, a vending machine, and other household apparatuses.

A program running on the mobile station device and the base station device 1 according to the present invention is a program (a program for causing a computer to operate) that controls a CPU and the like in such a manner as to realize the functions according to the embodiment of the present invention. Then, pieces of information that are handled in these apparatuses are temporarily stored in a RAM while being processed. Thereafter, the pieces of information are stored in various ROMs or HDDs, and if need be, are read by the CPU to be modified or written. As a recording medium on which to store the program, among a semiconductor medium (for example, a ROM, a nonvolatile memory card, and the like), an optical storage medium (for example, a DVD, an MO, an MD, a CD, a BD, and the like), a magnetic storage medium (for example, a magnetic tape, a flexible disk, and the like), and the like, any one may be possible. Furthermore, in some cases, the functions according to the embodiments described above are realized by running the loaded program, and in addition, the functions according to the present invention are realized in conjunction with an operating system or other application programs, based on an instruction from the program.

Furthermore, in a case where programs are distributed on the market, the programs, each of which is stored on a portable recording medium, can be distributed or the program can be transmitted to a server computer that connects through a network such as the Internet. In this case, a storage device in the server computer also is included in the present invention. Furthermore, some of or all of the portions of the mobile station device and the base station device 1 according to the embodiments described above may be realized as an LSI that is a typical integrated circuit. Each functional block of the mobile station device and the base station device 1 may be individually realized as a processor, and some of, or all of the functional blocks may be integrated into a processor. Furthermore, a technique of the integrated circuit is not limited to the LSI, and an integrated circuit for the functional block may be realized with a dedicated circuit or a general-purpose processor. Furthermore, if with advances in a semiconductor technology, a circuit integration technology with which an LSI is replaced appears, it is also possible to use an integrated circuit to which such a technology is applied.

### REFERENCE SIGNS LIST

1 BASE STATION DEVICE
2, 2-1, 2-2, 2-3, 2-4, 2-u TERMINAL DEVICE
21 CHANNEL CODING MODULE
23 DATA MODULATION MODULE
25 MAPPING MODULE
27 PRE-CODING MODULE
27-1 LINEAR FILTER GENERATION MODULE
27-2 PERTURBATION VECTOR SEARCH MODULE
27-3 TRANSMIT SIGNAL GENERATION MODULE
29 ANTENNA MODULE
29-1 IFFT MODULE
29-2 GI INSERTION MODULE
29-3 WIRELESS TRANSMISSION MODULE
29-4 WIRELESS RECEPTION MODULE
29-5 ANTENNA
31 CONTROL INFORMATION ACQUISITION MODULE
33 CHANNEL STATE INFORMATION ACQUISITION MODULE
51 TERMINAL ANTENNA MODULE
51-1 WIRELESS RECEPTION MODULE
51-2 WIRELESS TRANSMISSION MODULE
51-3 GI REMOVAL MODULE
51-4 FFT MODULE
51-5 REFERENCE SIGNAL SEPARATION MODULE
51-6 ANTENNA
53 CHANNEL STATE ESTIMATOR
55 FEEDBACK INFORMATION GENERATION MODULE
57 CHANNEL EQUALIZATION MODULE
59 DEMAPPING MODULE
61 DATA DEMODULATION MODULE
63 CHANNEL DECODING MODULE

1. A base station device that includes multiple antennas and that performs non-linear pre-coding and spatial multiplexing on signals destined for multiple terminal devices and thus performs wireless communication, the base station device comprising:
a channel state information acquisition module that acquires channel state information between the base station device and the terminal device;
a perturbation vector search module that searches for a perturbation vector which that is received by each of the multiple terminal devices and which suppresses inter-user interference, using a linear filter that is generated based on the channel state information; and
a transmit signal generation module that calculates a transmit signal vector based on the generated linear filter, the perturbation vector and a transmit data vector.

2. The base station device according to claim 1,
wherein the perturbation vector search module performs a first method in which perturbation term candidate points that are expressed using Gaussian integers of which the number is determined in advance are searched for the perturbation vector, or a second method in which the perturbation vector that is received by at least one terminal device among the multiple terminal devices and that suppresses the inter-user interference is searched for.

3. The base station device according to claim 2,
wherein based on at least one among a modulation scheme, a coding rate, and the channel state information, which are applied to the signals, the perturbation vector search module uses the first method or the second method at the same time or selectively.

4. The base station device according to claim 2,
wherein in time or frequency domains, the perturbation vector search module periodically allocates the terminal device that suppresses the inter-user interference, among the multiple terminal devices.

5. The base station device according to claim 1,
wherein the channel state information acquisition module acquires first channel state information based on control information associated with the first channel state information that is notified by each of the multiple terminal devices, and acquires error information between the first channel state information and the control information or error information between the first channel state information and second channel state information on a channel on which the signals are propagated as wireless signals based on the first channel state information.

6. The base station device according to claim 1,
wherein the channel state information acquisition module acquires first channel state information based on control information associated with the first channel state information that is notified by each of the multiple terminal devices, and acquires error information between the first channel state information that is notified by each of the multiple terminal devices and the control information or error information between the first channel state information and second channel state information on a channel on which the signals are propagated as wireless signals.

7. The base station device according to claim 5,
wherein, based on the first channel state information and the error information, non-linear pre-coding is performed on the signals.

8. The base station device according to claim 7,
wherein the perturbation vector search module searches for the perturbation vector that is received by the terminal device which has a large amount of error information, and that suppresses the inter-user interference.

9. A terminal device that receives wireless signals on which non-linear pre-coding and spatial multiplexing are performed from a base station device that includes multiple antennas, the terminal device comprising:
a reference signal separation module that separates a data signal and a reference signal from each of the wireless signals;
a channel state estimator that estimates first channel state information between the base station device and the terminal device based on the reference signal;
a feedback information generation module that generates control information associated with the first channel state information that is notified to the base station device, from the first channel state information; and
a wireless transmission module that transmits the control information to the base station device,
wherein the feedback information generation module generates error information between the first channel state information and the control information.

10. The terminal device according to claim 9,
wherein the feedback information generation module generates error information between second channel state information between the terminal device and the base station device on which the data signal that is received at a first point in time or on a first frequency is propagated, and the first channel state information that is estimated based on the reference signal that is received at a second point in time or on a second frequency.

11. (canceled)
